(19) United States
(12) Patent Application Publication
(10) Pub. No.: US 2025/0013121 A1
(43) Pub. Date: Jan. 9, 2025

(54) CAMERA MODULE

(71) Applicant: Samsung Electro-Mechanics Co., Ltd., Suwon-si (KR)

(72) Inventor: Hae Seung HYUN, Suwon-si (KR)

(73) Assignee: Samsung Electro-Mechanics Co., Ltd., Suwon-si (KR)

(21) Appl. No.: 18/648,569

(22) Filed: Apr. 29, 2024

(30) Foreign Application Priority Data
Jul. 4, 2023 (KR) 10-2023-0086734
Nov. 30, 2023 (KR) 10-2023-0171563

(51) Int. Cl. G03B 5/02; G03B 3/10; G03B 5/04; G03B 9/06; G03B 17/12

(52) U.S. Cl. CPC G03B 5/02; G03B 3/10; G03B 5/04; G03B 9/06; G03B 17/12; G03B 2205/0015; G03B 2205/0069

(57) ABSTRACT

A camera module includes an aperture module configured to move in a direction of one or more axes among three axes intersecting each other and including an entrance hole through which light passes; a lens module coupled to the aperture module and configured to move together with the aperture module; a housing accommodating the aperture module and the lens module; an aperture driving unit generating driving force to change a size of the entrance hole and including an aperture magnet and an aperture coil; and an actuator driving unit generating driving force in the direction of one or more of the axes to move the aperture module, and including one or more magnets and one or more coils, wherein the aperture magnet or the aperture coil is disposed on the aperture module, and the one or more magnets or the one or more coils are disposed on the aperture module.

### CROSS-REFERENCE TO RELATED APPLICATIONS

This application claims the benefit under 35 USC 119(a) of Korean Patent Application Nos. 10-2023-0086734 filed on Jul. 4, 2023, and 10-2023-0171563 filed on Nov. 30, 2023, in the Korean Intellectual Property Office, the entire disclosures of which are incorporated herein by reference for all purposes.

### BACKGROUND

### 1. Field

The present disclosure relates to a camera module.

### 2. Description of Related Art

Recently, a camera module has been employed in a portable electronic device such as a smartphone, a tablet PC, and a laptop.

Also, recently, an aperture module for controlling the amount of light has been applied to a mobile camera module.

Since the amount of light incident to a camera module may be adjusted by an aperture module, good quality images may be obtained even under various illumination conditions.

A lens module of a camera module may move for focus adjustment and optical image stabilization. In this case, in a structure in which an aperture module is fixed, a distance between a lens module and an aperture module may change, so that it may be difficult to satisfy desired driving properties.

Also, when an aperture module is configured to move together with a lens module, focus adjustment and optical image stabilization performance may be deteriorated due to a weight of an aperture module and a lens module.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes an aperture module configured to move in a direction of one or more axes among three axes intersecting each other and including an entrance hole configured to allow light to pass therethrough in an optical axis direction; a lens module coupled to the aperture module and configured to move together with the aperture module; a housing accommodating the aperture module and the lens module; an aperture driving unit configured to generate a driving force to change a size of the entrance hole and including an aperture magnet and an aperture coil facing the aperture magnet; and an actuator driving unit configured to generate a driving force in the direction of one or more of the axes to move the aperture module, and including one or more magnets and one or more coils facing the one or more magnets, wherein the aperture magnet or the aperture coil is disposed on the aperture module, and the one or more magnets or the one or more coils are disposed on the aperture module.

The lens module may include a first lens unit and a second lens unit spaced apart from each other in the optical axis direction, and the aperture module may be disposed between the first lens unit and the second lens unit.

The aperture module may further include a base and a cover coupled to each other and forming an internal space; and a plurality of blades forming the entrance hole and disposed in the internal space, wherein the first lens unit may be mounted on an upper surface of the cover, and the second lens unit may be accommodated in the base.

The aperture module may further include a base; a plurality of blades forming the entrance hole, coupled to the base, and configured to rotate; and a holder configured to move in a direction perpendicular to the optical axis direction with respect to the base, wherein the aperture magnet may be disposed on the holder, and the aperture coil may be disposed on the housing.

The lens module may be accommodated in the base, the one or more magnets may include a plurality of magnets disposed on the base, and the plurality of magnets may be disposed below the aperture magnet in the optical axis direction.

The aperture module may further include an extension portion extending downwardly in the optical axis direction from two sidewalls of the base, and the plurality of magnets may be disposed on the extension portion.

The aperture module and the lens module may be further configured to move together in a first axis direction perpendicular to the optical axis direction and a second axis direction perpendicular to both the optical axis direction and the first axis direction, the one or more magnets may include a plurality of magnets disposed on the aperture module, and the one or more coils may include a plurality of coils disposed on the housing.

The camera module may further include a carrier disposed in the housing; and a focus adjustment unit including a first magnet disposed on the carrier and a first coil facing the first magnet, wherein the aperture module and the lens module may be disposed in the carrier.

The aperture module may further include a base; and a plurality of blades forming the entrance hole, coupled to the base, and configured to rotate, the one or more magnets may include a second magnet and a third magnet both disposed on the base, and the one or more coils may include a second coil facing the second magnet and a third coil facing the third magnet.

The camera module may further include a plurality of ball members disposed between the base and the carrier.

The camera module may further include a plurality of guide grooves accommodating the plurality of ball members and formed in a surface of the base and a surface of the carrier facing each other in the optical axis direction, wherein a size of the guide groove may be greater than a size of the plurality of ball members.

The camera module may further include a guide frame disposed between the aperture module and the carrier; a plurality of ball members disposed between the carrier and the guide frame; and a plurality of ball members disposed between the guide frame and the aperture module.

The aperture module and the lens module may be configured to move together in the optical axis direction, the one or more magnets may include a first magnet disposed on the aperture module, and the one or more coils may include a first coil facing the first magnet.

The camera module may further include an optical image stabilization (OIS) carrier disposed in the housing, wherein the aperture module and the lens module may be disposed in the OIS carrier, and the OIS carrier, the aperture module, and the lens module may be configured to move together in a first axis direction perpendicular to the optical axis direction, and a second axis direction perpendicular to both the optical axis direction and the first axis direction.

The one or more magnets may further include a second magnet and a third magnet disposed on the OIS carrier, and the one or more coils may further include a second coil disposed on the housing and facing the second magnet, and a third coil disposed on the housing and facing the third magnet.

The camera module may further include a guide frame disposed between the OIS carrier and the housing; a plurality of ball members disposed between the housing and the guide frame; and a plurality of ball members disposed between the guide frame and the OIS carrier.

The camera module may further include a first substrate disposed on the OIS carrier and including a portion made of a flexible material, wherein the aperture magnet may be disposed on the aperture module, and the first coil and the aperture coil may be disposed on the first substrate.

In another general aspect, a camera module includes an aperture module configured to move in an optical axis direction, a first axis direction perpendicular to the optical axis direction, and a second axis direction perpendicular to both the optical axis direction and the first axis direction, and including an entrance hole configured to allow light to pass therethrough in the optical axis direction; a lens module coupled to the aperture module and configured to move together with the aperture module; a carrier accommodating the aperture module and the lens module; a housing accommodating the carrier; and an optical image stabilization unit including a plurality of magnets disposed on the aperture module, and a plurality of coils disposed on the housing, wherein an attractive force acts between the aperture module and the carrier in the optical axis direction.

The camera module may further include an aperture driving unit including an aperture magnet disposed on the aperture module, and an aperture coil disposed on the housing; and a focus adjustment unit including a first magnet disposed on the carrier, and a first coil disposed on the housing, wherein the aperture magnet and one of the plurality of magnets may be spaced apart from each other in the first axis direction, and the first magnet and another one of the plurality of magnets are spaced apart from each other in the second axis direction.

In another general aspect, a camera module includes an aperture module configured to move in an optical axis direction, a first axis direction perpendicular to the optical axis direction, and a second axis direction perpendicular to both the optical axis direction and the first axis direction, and including an entrance hole configured to allow light to pass therethrough in the optical axis direction; a lens module coupled to the aperture module and configured to move together with the aperture module; an optical image stabilization (OIS) carrier accommodating the aperture module and the lens module; a housing accommodating the OIS carrier; and a focus adjustment unit including a first magnet disposed on the aperture module, and a first coil facing the first magnet, wherein an attractive force acts between the aperture module and the OIS carrier in a direction perpendicular to the optical axis direction.

The camera module may further include an aperture driving unit including an aperture magnet disposed on the aperture module, and an aperture coil facing the aperture magnet; a first substrate coupled to the OIS carrier and having the first coil and the aperture coil disposed thereon; and an optical image stabilization unit including a second magnet and a third magnet disposed on the OIS carrier, and a second coil and a third coil disposed on the housing, wherein a portion of the first substrate may be spaced apart from the OIS carrier in a direction perpendicular to the optical axis direction, may extend along a side surface of the OIS carrier, and may be mounted on an external side surface of the housing.

In another general aspect, an aperture module includes a base configured to move in an optical axis direction, a first axis direction perpendicular to the optical axis direction, and a second axis direction perpendicular to both the optical axis direction and the first axis direction; a plurality of blades coupled to the base, forming an entrance hole configured to allow light to pass therethrough in the optical axis direction, and configured to rotate relative to the base to change a size of the entrance hole; an aperture magnet coupled to the base and configured to rotate the blades to change the size of the entrance hole; and a plurality of magnets mounted on the base and configured to move the base in the first axis direction and the second axis direction.

The aperture module may further include a holder disposed on the base, coupled to the plurality of blades, and configured to move in the first axis direction or the second axis direction relative to the base to rotate the blades to change the size of the entrance hole, wherein the aperture magnet may be disposed on the holder.

The aperture module may further include a rotating body disposed between the base and the plurality of blades, coupled to the plurality of blades, and configured to rotate relative to the base to rotate the blades to change the size of the entrance hole; and an aperture coil disposed between the base and the rotating member and coupled to the base, wherein the aperture magnet may be disposed on the rotating body facing the aperture coil, and cooperate with the aperture coil to rotate the rotating body to rotate the blades to change the size of the entrance hole.

The aperture module may further include a first magnet disposed on the base and configured to move the base in the optical axis direction, wherein the plurality of magnets may include a second magnet disposed on the base and configured to move the base in the first axis direction; and a third magnet disposed on the base and configured to move the base in the second axis direction.

A camera module may include the aperture module; and a carrier configured to move in the optical axis direction, the first axis direction, and the second axis direction, wherein the aperture module may be disposed in the carrier and configured to move in the optical axis direction, the first axis direction, and the second axis direction together with the carrier, the camera module may further include a first magnet mounted on the carrier and configured to move the carrier and the aperture module in the optical axis direction, and the plurality of magnets may include a second magnet mounted on the base and configured to move the aperture module and the carrier in the first axis direction; and a third magnet mounted on the base and configured to move the aperture module and the carrier in the second axis direction.

In another general aspect, an aperture module includes a base configured to move in an optical axis direction, a first axis direction perpendicular to the optical axis direction, and a second axis direction perpendicular to both the optical axis direction and the first axis direction; a plurality of blades coupled to the base, forming an entrance hole configured to allow light to pass therethrough in the optical axis direction, and configured to rotate relative to the base to change a size of the entrance hole; an aperture magnet coupled to the base and configured to rotate the blades to change the size of the entrance hole; and a first magnet mounted on the base and configured to move the base in the optical axis direction.

The aperture module may further include a holder disposed on the base, coupled to the plurality of blades, and configured to move in the first axis direction or the second axis direction relative to the base to rotate the blades to change the size of the entrance hole, wherein the aperture magnet may be disposed on the holder.

A camera module may include the aperture module; and an optical image stabilization (OIS) carrier configured to move in the first axis direction and the second axis direction, wherein the aperture module may be disposed in the OIS carrier and may be configured to move in the optical axis direction relative to the OIS carrier, and the first axis direction and the second axis direction together with the OIS carrier, the first magnet may be may be further configured to move the aperture module in the optical axis direction relative to the carrier, and the camera module may further include a second magnet mounted on the OIS carrier and configured to move the OIS carrier and the aperture module in the first axis direction; and a third magnet mounted on the OIS carrier and configured to move the OIS carrier and the aperture module in the second axis direction.

Other features and aspects will be apparent from the following detailed description, the drawings, and the claims.

### BRIEF DESCRIPTION OF DRAWINGS

FIG. 1 is an exploded perspective diagram illustrating a camera module according to an embodiment of the present disclosure.

FIG. 2 is an exploded perspective diagram illustrating an aperture module of the camera module of FIG. 1.

FIG. 3 is a perspective diagram illustrating a base of the aperture module of FIG. 2 viewed from below.

FIG. 4 is an exploded perspective diagram illustrating a camera module according to another embodiment of the present disclosure.

FIG. 5 is an exploded perspective diagram illustrating a camera module according to another embodiment of the present disclosure.

FIG. 6 is a perspective diagram illustrating an aperture module of the camera module of FIG. 5.

FIG. 7 is an exploded perspective diagram illustrating a camera module according to another embodiment of the present disclosure.

FIG. 8 is a perspective diagram illustrating a portion of the camera module of FIG. 7.

FIG. 9 is a perspective diagram illustrating an aperture module and an OIS carrier of FIGS. 7 and 8.

FIG. 10A is a plan diagram illustrating a first substrate of FIGS. 7 to 9.

FIG. 10B is a perspective diagram illustrating the first substrate of FIGS. 7 to 9.

FIG. 11 is an exploded perspective diagram illustrating a camera module according to another embodiment of the present disclosure.

FIG. 12 is an exploded perspective diagram illustrating an aperture module according to another embodiment of the present disclosure.

FIG. 13 is an exploded perspective diagram illustrating an example in which an aperture driving unit of the aperture module of FIG. 12 is disposed on a base and a rotating body of the aperture module of FIG. 12.

FIG. 14 is a plan diagram illustrating a state in which a rolling portion of the aperture module of FIG. 12 is disposed on the base.

FIG. 15 is a perspective diagram illustrating a state in which a pulling yoke portion and an auxiliary yoke of the camera module of FIG. 12 are separated from the base.

FIG. 16 is a diagram illustrating an arrangement of a magnet portion, a pulling yoke portion, and an auxiliary yoke of the camera module of FIG. 12 viewed from the side.

FIG. 17 is a cross-sectional diagram illustrating the aperture module of FIG. 12.

FIG. 18 is a plan diagram illustrating a rolling portion of the aperture module of FIG. 12 disposed in a guide groove of the aperture module of FIG. 12.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In embodiments, an optical axis (Z-axis) direction may refer to a direction extending up and down the optical axis (Z-axis) of the lens module 200 or a direction parallel to the optical axis (Z-axis).

A first axis (X-axis) direction may refer to a direction perpendicular to the optical axis (Z-axis) direction, and a second axis (Y-axis) direction may refer to a direction perpendicular to both the optical axis (Z-axis) direction and the first axis (X-axis) direction.

Embodiments relate to a camera module, and the camera module may be mounted in portable electronic devices such as a mobile communication terminal, a smartphone, and a tablet PC.

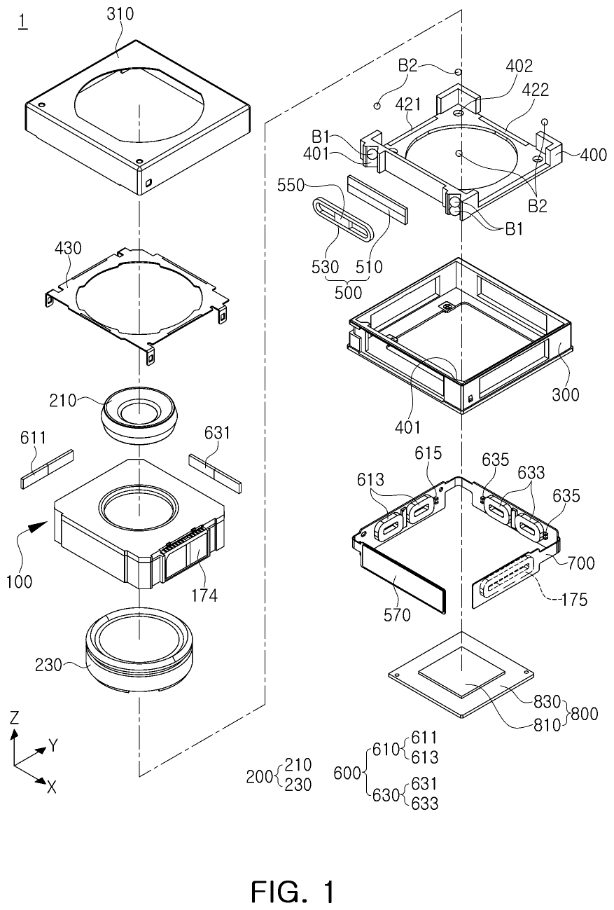

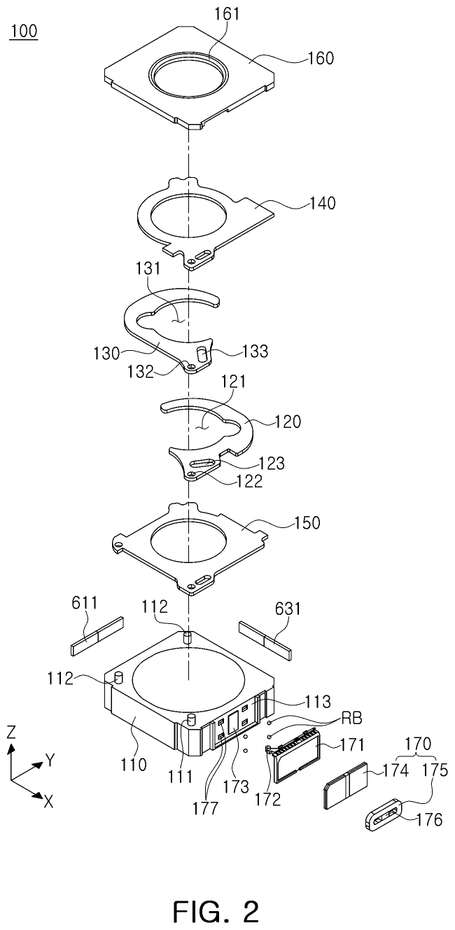

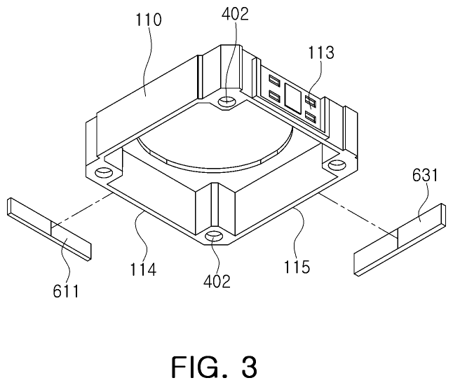

FIG. 1 is an exploded perspective diagram illustrating a camera module according to an embodiment of the present disclosure. FIG. 2 is an exploded perspective diagram illustrating an aperture module of the camera module of FIG. 2. FIG. 3 is a perspective diagram illustrating a base of the aperture module of FIG. 2 viewed from below.

Referring to FIGS. 1 to 3, a camera module 1 according to an embodiment may include an aperture module 100, a lens module 200, and a housing 300.

The aperture module 100 may be disposed in the housing 300 and may control the amount of light incident to the camera module 1. For example, the aperture module 100 may selectively change the amount of light incident to the camera module 1. In other words, the aperture module 100 may control an f-number of the camera module 1.

The aperture module 100 may have an entrance hole through which light passes, and the amount of light incident to the camera module 1 may be adjusted by changing a size of the entrance hole.

For example, in a high-illuminance environment, a relatively small amount of light may be incident to the camera module 1, and in a low-illuminance environment, a relatively large amount of light may be incident to the camera module 1. Accordingly, image quality may be maintained consistently even under various illuminance conditions.

The aperture module 100 may move in a direction of one or more axes among three axes intersecting each other. For example, the aperture module 100 may move in one or more of an optical axis (Z-axis) direction, a first axis (X-axis) direction, and a second axis (Y-axis) direction.

In an embodiment, the aperture module 100 may be configured to move in the optical axis (Z-axis) direction, the first axis (X-axis) direction, and the second axis (Y-axis) direction.

The first axis (X-axis) direction and the second axis (Y-axis) direction may be perpendicular to the optical axis (Z-axis) direction. Also, the first axis (X-axis) direction and the second axis (Y-axis) direction may be perpendicular to each other.

The lens module 200 may move in the direction of one or more of the three axes intersecting each other. For example, the lens module 200 may move in one or more of the optical axis (Z-axis) direction, the first axis (X-axis) direction, and the second axis (Y-axis) direction.

In an embodiment, the lens module 200 may be configured to move in the optical axis (Z-axis) direction, the first axis (X-axis) direction, and the second axis (Y-axis) direction.

The lens module 200 may be coupled to the aperture module 100. The lens module 200 may include a first lens unit 210 and a second lens unit 230 spaced apart from each other in the optical axis (Z-axis) direction. The first lens unit 210 may include one or more lenses, and the second lens unit 230 may include a plurality of lenses.

The aperture module 100 may be disposed between the first lens unit 210 and the second lens unit 230. For example, the first lens unit 210 may be coupled to an upper portion of the aperture module 100, and the second lens unit 230 may be coupled to a lower portion of the aperture module 100.

When the aperture module 100 is disposed between the first lens unit 210 and the second lens unit 230, a desired f-number may be implemented while reducing a moving distance between the plurality of blades of the aperture module 100. Accordingly, the f-number may be adjusted with low power.

The aperture module 100 and the lens module 200 may be coupled to each other and may move together.

That is, the aperture module 100 and the lens module 200 may move together in the optical axis (Z-axis) direction for focus adjustment. Also, the aperture module 100 and the lens module 200 may move together in a direction perpendicular to the optical axis (Z-axis) for optical image stabilization.

To move the aperture module 100 and the lens module 200, the camera module 1 may further include an actuator driving unit.

The actuator driving unit may include either one or both of a focus adjustment unit 500 and an optical image stabilization unit 600.

In embodiments, the actuator driving unit may refer to one of the focus adjustment unit 500 or the optical image stabilization unit 600, or may refer to both.

The aperture module 100 and the lens module 200 may be moved together in the optical axis (Z-axis) direction by the focus adjustment unit 500. By the optical image stabilization unit 600, the aperture module 100 and the lens module 200 may be moved together in the first axis (X-axis) direction and the second axis (Y-axis) direction.

During the focus adjustment and the optical image stabilization, the lens module 200 and the aperture module 100 may move together so that relative positions therebetween may not change.

Referring to FIG. 2, the aperture module 100 may include a base 110, a plurality of blades, and an aperture driving unit 170.

The plurality of blades may include a first blade 120 and a second blade 130. In the embodiment, two blades may be provided, but the number of the plurality of blades is not limited thereto.

The first blade 120 may include a first through-hole 121, and the second blade 130 may include a second through-hole 131.

A portion of the first blade 120 and a portion of the second blade 130 may be disposed to overlap each other in the optical axis (Z-axis) direction. A portion of the first blade 120 and a portion of the second blade 130 may overlap each other in the optical axis (Z-axis) direction and may form an entrance hole through which light passes. The entrance hole may be defined by the first through-hole 121 and the second through-hole 131.

Each of the first through-hole 121 and the second through-hole 131 may have a shape having an open side. Also, the shapes of the first through-hole 121 and the second through-hole 131 may be opposite to each other. A first blade 120 and a second blade 130 may rotate around a first protrusion 111 of the base 110. The first through-hole 121 and the second through-hole 131 may have symmetrical shapes in a direction of rotation.

The positions of the first blade 120 and the second blade 130 may be changed by the aperture driving unit 170. Accordingly, a size of the entrance hole may change depending on positions of the first blade 120 and the second blade 130. For example, the first blade 120 and the second blade 130 may be configured to be rotated in opposite directions by the aperture driving unit 170.

By changing the positions of the first blade 120 and the second blade 130, the size of the entrance hole defined by the first through-hole 121 and the second through-hole 131 may change. The entrance hole may have a round shape or a polygonal shape depending on the shapes of the first through-hole 121 and the second through-hole 131.

The first blade 120 may include a first rotation hole 122, and the second blade 130 may include a second rotation hole 132. For example, the first blade 120 may have a first rotation hole 122 on an external side end, and the first rotation hole 122 may have a shape penetrating the first blade 120 in the optical axis (Z-axis) direction. Also, the second blade 130 may have a second rotation hole 132 on an external side end, and the second rotation hole 132 may have a shape penetrating the second blade 130 in the optical axis (Z-axis) direction.

The first blade 120 and the second blade 130 may be coupled to the base 110. For example, the first protrusion 111 protruding in the optical axis (Z-axis) direction may be disposed on the base 110, and the first rotation hole 122 of the first blade 120 and the second rotation hole 132 of the second blade 130 may be inserted onto the first protrusion 111.

The first protrusion 111 may form a rotating shaft of the first blade 120 and a rotating shaft of the second blade 130. The first rotation hole 122 and the second rotation hole 132 may have a round shape so that the first blade 120 and the second blade 130 rotate using the first protrusion 111 as a rotating shaft.

The first blade 120 may include a first guide hole 123, and the second blade 130 may include a second guide hole 133. The first guide hole 123 may have a long shape in one direction, and the second guide hole 133 may have a long shape in another direction.

A portion of the first guide hole 123 and a portion of the second guide hole 133 may be disposed to overlap each other in the optical axis (Z-axis) direction. Also, the first guide hole 123 and the second guide hole 133 may be disposed to have slopes relative to each other on a plane perpendicular to the optical axis (Z-axis).

Each of the first guide hole 123 of the first blade 120 and the second guide hole 133 of the second blade 130 may be coupled to a holder 171 of the aperture driving unit 170, which will be described later. As the holder 171 moves, the first blade 120 and the second blade 130 may rotate in opposite directions using the first protrusion 111 as a rotating shaft.

The aperture driving unit 170 may include an aperture magnet 174 and an aperture coil 175.

One of the aperture magnet 174 and the aperture coil 175 may be disposed on the aperture module 100, and the other one of the aperture magnet 174 and the aperture coil 175 may be disposed on the housing 300. In the description below, an embodiment in which the aperture magnet 174 is disposed on the aperture module 100 will be described.

The aperture module 100 may further include the holder 171 configured to move with respect to the base 110.

The holder 171 may be disposed on the base 110 so that the holder 171 may move in a direction perpendicular to the optical axis (Z-axis). The aperture magnet 174 may be mounted on the holder 171. The aperture coil 175 may be disposed on the housing 300 facing the aperture magnet 174. For example, a substrate 700 may be disposed on the housing 300, and the aperture coil 175 may be disposed on one surface of the substrate 700.

The aperture magnet 174 may be magnetized so that one surface (e.g., a surface facing the aperture coil 175) may have both an N-pole and an S-pole. As an example, an N-pole, a neutral region, and an S-pole may be sequentially disposed on one surface of the aperture magnet 174 facing the aperture coil 175 in the direction perpendicular to the optical axis (Z-axis) (e.g., the moving direction of the holder 171).

The aperture magnet 174 and the holder 171 may be moving members configured to move in the optical axis (Z-axis) direction, the first axis (X-axis) direction, and the second axis (Y-axis) direction together with the base 110, and the aperture coil 175 may be a fixed member fixed to the housing 300.

The holder 171 may be disposed on a first sidewall 113 of the base 110. The first sidewall 113 of the base 110 may have a shape extending from an upper surface of the base 110 in the optical axis (Z-axis) direction.

The holder 171 may move relative to the first sidewall 113 of the base 110 in a direction perpendicular to the optical axis (Z-axis).

For example, the aperture magnet 174 may be disposed on the holder 171, and the holder 171 may move in a direction perpendicular to the optical axis (Z-axis) in response to an electromagnetic force generated by the aperture magnet 174 and the aperture coil 175.

A rolling member RB may be disposed between the first sidewall 113 of the base 110 and the holder 171. For example, the rolling member RB may be disposed between the first sidewall 113 of the base 110 and the holder 171 and may reduce friction when the holder 171 moves.

The rolling member RB may include a plurality of balls. The plurality of balls may roll in a direction perpendicular to the optical axis (Z-axis) when the holder 171 moves in a direction perpendicular to the optical axis (Z-axis).

A pulling yoke 173 may be disposed on the first sidewall 113 of the base 110. The pulling yoke 173 may be disposed at a position facing the aperture magnet 174.

The aperture magnet 174 and the pulling yoke 173 may generate an attractive force therebetween. For example, the pulling yoke 173 may be made of a magnetic material.

Due to the attractive force generated between the aperture magnet 174 and the pulling yoke 173, the rolling member RB may be held in contact with each of the first sidewall 113 of the base 110 and the holder 171 of the base 110.

An accommodation groove 177 may be formed in surfaces of the first sidewall 113 of the base 110 and the holder 171 facing each other. The rolling member RB may be disposed in the accommodation groove 177.

In an embodiment, the camera module 1 may sense a position of the holder 171 in a direction perpendicular to the optical axis (Z-axis).

To this end, an aperture position sensor 176 may be provided. The aperture position sensor 176 may be disposed on the substrate 700 facing the aperture magnet 174. The aperture position sensor 176 may be a Hall sensor.

The holder 171 may include a guide protrusion 172 protruding in the optical axis (Z-axis) direction. The guide protrusion 172 may be inserted into the first guide hole 123 of the first blade 120 and the second guide hole 133 of the second blade 130.

For example, a portion of the first guide hole 123 and a portion of the second guide hole 133 may overlap in the optical axis (Z-axis) direction, and the guide protrusion 172 may be inserted into the overlapping portion.

As the holder 171 moves in a direction perpendicular to the optical axis (Z-axis), the guide protrusion 172 may also move in a direction perpendicular to the optical axis (Z-axis) in the first guide hole 123 and the second guide hole 133.

Accordingly, as the holder 171 moves, the first blade 120 and the second blade 130 may rotate in opposite directions using the first protrusion 111 of the base 110 as a rotating shaft.

By changing positions of the first blade 120 and the second blade 130, entrance holes of various sizes may be formed.

The aperture module 100 may further include a cover 160, a first spacer 140, and a second spacer 150. The cover 160 may be coupled to the base 110 via holes (not shown) in a lower surface of the cover 160 accommodating the first protrusion 111 and two second protrusions 112 of the base 110, and the plurality of blades may be disposed in a space between the cover 160 and the base 110. Also, the first spacer 140 may be disposed between the cover 160 and the plurality of blades, and the second spacer 150 may be disposed between the plurality of blades and the base 110.

The first spacer 140 may have a through-hole through which light passes, and may be coupled to the base 110 via a hole accommodating the first protrusion 111, and a notch accommodating a first one of the two protrusions 112. A size of the through-hole of the first spacer 140 may be greater than a maximum size of the entrance hole formed by the plurality of blades.

The first spacer 140 may cover at least a portion of an upper surface of the plurality of blades. A surface of the first spacer 140 may be coated black.

The second spacer 150 may have a through-hole through which light passes, and may be coupled to the base 110 via a hole accommodating the first protrusion 111, a notch accommodating the first one of the two protrusions 112, and a hole accommodating a second one of the two protrusions 112. A size of the through-hole of the second spacer 150 may be greater than the maximum size of the entrance hole formed by the plurality of blades. Also, the size of the through-hole of the second spacer 150 may be smaller than the size of the through-hole of the first spacer 140.

The second spacer 150 may cover at least a portion of a lower surface of the plurality of blades. A surface of the second spacer 150 may be coated black.

The aperture module 100 may be disposed between the first lens unit 210 and the second lens unit 230. For example, the first lens unit 210 may be coupled to an upper surface of the cover 160 of the aperture module 100. The second lens unit 230 may be accommodated in the base 110. For example, the second lens unit 230 may be coupled to an internal bottom surface of the base 110 (see FIG. 3). The internal bottom surface of the base 110 may be an internal surface of the base 110 facing away from the upper surface of the base 110 (the surface of the base 110 facing the cover 160 in the optical axis (Z-axis) direction).

The upper surface of the cover 160 of the aperture module 100 may include a first groove 161, and the internal bottom surface of the base 110 may include a second groove (not shown in FIG. 3).

The first lens unit 210 may be coupled to the first groove 161, and the second lens unit 230 may be coupled to the second groove.

The first groove 161 and the second groove may have a function of guiding a coupling position of the first lens unit 210 and a coupling position of the second lens unit 230 so that the optical axis (Z-axis) of the first lens unit 210 and the optical axis (Z-axis) of the second lens unit 230 may be aligned.

Referring to FIG. 1, the camera module 1 according to an embodiment may further include a carrier 400, a case 310, and an image sensor module 800.

The carrier 400 may be disposed in the housing 300 and may be configured to move relative to the housing 300 in the optical axis (Z-axis) direction.

The housing 300 may have a shape in which an upper portion and a lower portion thereof are open, the carrier 400 may be disposed in an internal space of the housing 300, and the aperture module 100 and the lens module 200 may be accommodated in the carrier 400.

The carrier 400, the lens module 200, and the aperture module 100 may be configured to move together in the optical axis (Z-axis) direction. Accordingly, a distance between the lens module 200 and the image sensor 810 may be change to adjust a focus of the camera module 1.

Also, the lens module 200 and the aperture module 100 may be configured to move in a direction perpendicular to the optical axis (Z-axis) direction to correct shaking during imaging.

The camera module 1 may include an actuator driving unit. The actuator driving unit may generate a driving force in one or more of the optical axis (Z-axis) direction, the first axis (X-axis) direction, and the second axis (Y-axis) direction. The actuator driving unit may include one or more magnets and one or more coils.

For example, the actuator driving unit may include the focus adjustment unit 500 generating a driving force in the optical axis (Z-axis) direction, and the optical image stabilization unit 600 generating a driving force in a direction perpendicular to the optical axis (Z-axis) direction.

The image sensor module 800 may be a device for converting incident light into an electrical signal through the lens module 200.

As an example, the image sensor module 800 may include an image sensor 810 and a printed circuit board 830 to which the image sensor 810 is connected, and may further include an infrared filter (not shown).

The infrared filter may block light in the infrared region of light incident through the lens module 200.

The image sensor 810 may convert incident light through the lens module 200 into an electrical signal. As an example, the image sensor 810 may be a charge-coupled device (CCD) or a complementary metal-oxide-semiconductor (CMOS) device.

The electrical signal converted by the image sensor 810 may be output as an image through a display unit of a portable electronic device in which the camera module 1 is mounted.

The image sensor 810 may be fixed to the printed circuit board 830 and may be electrically connected to the printed circuit board 830 by wire bonding.

The image sensor module 800 may be disposed in a lower portion of the housing 300.

The case 310 may be coupled to the housing 300 to surround an external surface of the housing 300, and may function to protect internal components of the camera module 1.

The focus adjustment unit 500 may move the aperture module 100 and the lens module 200 to focus on a subject. For example, the focus adjustment unit 500 may move the carrier 400 by generating a driving force in the optical axis (Z-axis) direction. Since the aperture module 100 and the lens module 200 are disposed in the carrier 400, the carrier 400, the aperture module 100, and the lens module 200 may move together in the optical axis (Z-axis) direction in response to the driving force generated by the focus adjustment unit 500.

The focus adjustment unit 500 may include a first magnet 510 and a first coil 530.

The first magnet 510 and the first coil 530 may be disposed facing each other in a direction perpendicular to the optical axis (Z-axis).

One of the first magnet 510 and the first coil 530 may be disposed on the carrier 400, and the other one of the first magnet 510 and the first coil 530 may be disposed on the housing 300. In the description below, an embodiment in which the first magnet 510 is disposed on the carrier 400 and the first coil 530 is disposed on the carrier 300 will be described.

The first magnet 510 may be mounted on the carrier 400. As an example, the first magnet 510 may be mounted on one side surface of the carrier 400.

The first magnet 510 may be magnetized so that one surface (e.g., the surface facing the first coil 530) may have both an N-pole and an S-pole. For example, one surface of the first magnet 510 facing the first coil 530 may include an N-pole, a neutral region, and an S-pole sequentially arranged in the optical axis (Z-axis) direction.

The first coil 530 may be disposed facing the first magnet 510. For example, the first coil 530 may be disposed facing the first magnet 510 in a direction perpendicular to the optical axis (Z-axis).

The first coil 530 may be disposed on the substrate 700, and the substrate 700 may be mounted on the housing 300 so that the first magnet 510 and the first coil 530 may face each other in the direction perpendicular to the optical axis (Z-axis). As an example, the first coil 530 may be disposed on one surface of the substrate 700. The substrate 700 may be mounted on a side surface of housing 300 so that the first magnet 510 and the first coil 530 may face each other in the direction perpendicular to the optical axis (Z-axis).

The housing 300 may include an opening penetrating a side surface of the housing 300, and the first coil 530 disposed on the substrate 700 may directly face the first magnet 510 through the opening.

The first magnet 510 may be a moving member mounted on the carrier 400 and configured to move in the optical axis (Z-axis) direction together with the carrier 400, and the first coil 530 may be a fixed member fixed to the substrate 700.

When power is applied to the first coil 530, the carrier 400 may move in the optical axis (Z-axis) direction response to an electromagnetic force generated between the first magnet 510 and the first coil 530.

Since the aperture module 100 and the lens module 200 are accommodated in the carrier 400, the aperture module 100 and the lens module 200 may also move in the optical axis (Z-axis) direction together with the carrier 400.

A first ball member B1 may be disposed between the carrier 400 and the housing 300. For example, the first ball member B1 may be disposed between the carrier 400 and the housing 300 and may reduce friction when the carrier 400 moves.

The first ball member B1 may include a plurality of balls disposed in the optical axis (Z-axis) direction. The plurality of balls may roll in the optical axis (Z-axis) direction when the carrier 400 moves in the optical axis (Z-axis) direction.

A first yoke 570 may be disposed on the housing 300. The first yoke 570 may be disposed at a position facing the first magnet 510. For example, the first coil 530 may be disposed on one surface of the substrate 700, and the first yoke 570 may be disposed on the other surface of the substrate 700.

The first magnet 510 and the first yoke 570 may generate an attractive force therebetween. For example, the first yoke 570 may be made of a magnetic material. An attractive force may act between the first magnet 510 and the first yoke 570 in a direction perpendicular to the optical axis (Z-axis).

The first ball member B1 may be held in contact with each of the carrier 400 and the housing 300 by the attractive force acting between the first magnet 510 and the first yoke 570.

A first guide groove 401 may be formed in each of the carrier 400 and the housing 300.

For example, the first guide groove 401 may be formed in surfaces of the carrier 400 and the housing 300 facing each other.

The first guide groove 401 may extend in the optical axis (Z-axis) direction. The first ball member B1 may be disposed in the first guide groove 401.

The first ball member B1 may include a first ball group and a second ball group. The first ball group and the second ball group may be spaced apart from each other in a direction perpendicular to the optical axis (Z-axis) (e.g., the X-axis direction). The first ball group may include a plurality of balls disposed in the optical axis (Z-axis) direction. The number of balls included in the second ball group may be different from the number of balls included in the first ball group.

For example, the first ball group may include two or more balls disposed in the optical axis (Z-axis) direction, and the second ball group may include fewer balls than the number of balls included in the first ball group. The number of balls in each ball member may change as long as the number of balls in the first ball group and the number of balls in the second ball group are different.

In an embodiment, the camera module 1 may sense a position of the carrier 400 in the optical axis (Z-axis) direction.

To this end, a first position sensor 550 may be provided. The first position sensor 550 may be disposed on the substrate 700 facing the first magnet 510. The first position sensor 550 may be a Hall sensor.

The camera module 1 may correct shaking during imaging by moving the aperture module 100 and the lens module 200 in a direction perpendicular to the optical axis (Z-axis). To this end, the camera module 1 may include the optical image stabilization unit 600 moving the aperture module 100 and the lens module 200 in a direction perpendicular to the optical axis (Z-axis).

The aperture module 100 and the lens module 200 may move together in a direction perpendicular to the optical axis (Z-axis) in response to a driving force generated by the optical image stabilization unit 600.

For example, the aperture module 100 and the lens module 200 may move together in the first axis (X-axis) direction and the second axis (Y-axis) direction.

The optical image stabilization unit 600 may include a first sub-driving unit 610 and a second sub-driving unit 630. The first sub-driving unit 610 may generate a driving force in the first axis (X-axis) direction, and the second sub-driving unit 630 may generate a driving force in the second axis (Y-axis) direction.

The first sub-driving unit 610 may include a second magnet 611 and a second coil 613. The second magnet 611 and the second coil 613 may be disposed facing each other in the first axis (X-axis) direction.

One of the second magnet 611 and the second coil 613 may be disposed on the aperture module 100, and the other one of the second magnet 611 and the second coil 613 may be disposed on the housing 300. In the description below, an embodiment in which the second magnet 611 is disposed on the aperture module 100 will be described.

The second magnet 611 may be disposed on the aperture module 100. For example, the second magnet 611 may be mounted on a second sidewall 114 (see FIG. 3) of the base 110 of the aperture module 100.

The second magnet 611 may be magnetized so that one surface may have both N and S-poles. For example, one surface of the second magnet 611 may include an N-pole, a neutral region, and an S-pole sequentially arranged in the second axis (Y-axis) direction. The second magnet 611 may have a shape having a length in the second axis (Y-axis) direction.

The other surface of the second magnet 611 may be magnetized to have a polarity opposite to the polarity of the one surface of the second magnet 611. For example, the other surface of the second magnet 611 may include an S-pole, a neutral region, and an N-pole sequentially arranged in the second axis (Y-axis) direction so that the N-pole on the one surface opposes the S-pole on the other surface, the neutral region on the one surface opposes the neutral region on the other surface, and the S-pole on the one surface opposes the N-pole on the other surface.

The second coil 613 may be disposed facing the second magnet 611. For example, the second coil 613 may be disposed facing the second magnet 611 in the first axis (X-axis) direction.

The second coil 613 may include two coils arranged in the second axis (Y-axis) direction, and each of the two coils of the second coil 613 may have a toroid shape having a central opening.

One of the two coils of the second coil 613 may be disposed facing the N-pole of the one surface of the second magnet 611, and the other one of the two coils of the second coil 613 may be disposed facing the S-pole of the one surface of the second magnet 611.

Due to the polarity arrangement of the second magnet 611, magnetic field leakage may be prevented, and accordingly a sufficient driving force may be generated even with low power.

During the optical image stabilization, the second magnet 611 may be a moving member mounted on the aperture module 100, and the second coil 613 may be a fixed member fixed to the housing 300.

When power is applied to the second coil 613, the aperture module 100 and the lens module 200 may move in the first axis (X-axis) direction in response to an electromagnetic force generated between the second magnet 611 and the second coil 613.

The second magnet 611 and the second coil 613 may generate a driving force in the direction in which they face each other (e.g., the first axis (X-axis) direction).

The second sub-driving unit 630 may include a third magnet 631 and a third coil 633. The third magnet 631 and the third coil 633 may be disposed facing each other in the second axis (Y-axis) direction.

One of the third magnet 631 and the third coil 633 may be disposed on the aperture module 100, and the other one of the third magnet 631 and the third coil 633 may be disposed on the housing 300. In the description below, an embodiment in which the third magnet 631 is disposed on the aperture module 100 will be described.

The third magnet 631 may be disposed on the aperture module 100. For example, the third magnet 631 may be mounted on a third sidewall 115 of the base 110 of the aperture module 100.

The second sidewall 114 and the third sidewall 115 of the base 110 may be perpendicular to each other in a plane perpendicular to the optical axis (Z-axis).

The third magnet 631 may be magnetized so that one surface may have both an S-pole and an N-pole. For example, one surface of the third magnet 631 may include an S-pole, a neutral region, and an N-pole sequentially arranged in the first axis (X-axis) direction. The third magnet 631 may have a shape having a length in the first axis (X-axis) direction.

The other surface of the third magnet 631 may be magnetized to have a polarity opposite to the polarity of the one surface of the third magnet 631. For example, the other surface of the second magnet 611 may include an N-pole, a neutral region, and an S-pole sequentially arranged in the first axis (X-axis) direction so that the S-pole on the one surface opposes the N-pole on the other surface, the neutral region on the one surface opposes the neutral region on the other surface, and the N-pole on the one surface opposes the S-pole on the other surface.

The third coil 633 may be disposed facing the third magnet 631. For example, the third coil 633 may be disposed facing the third magnet 631 in the second axis (Y-axis) direction.

The third coil 633 may include two coils arranged in the first axis (X-axis) direction, and each of the two coils of the third coil 633 may have a toroid shape having a central opening.

One of the two coils of the third coil 633 may be disposed facing the S-pole of the one surface of the third magnet 631, and the other one of the two coils of the third coil 633 may be disposed facing the N-pole of the one surface of the third magnet 631.

Due to the polarity arrangement of the third magnet 631, magnetic field leakage may be prevented, and accordingly a sufficient driving force may be generated even with low power.

The second coil 613 and the third coil 633 may be disposed on the substrate 700. As an example, the second coil 613 and the third coil 633 may be disposed on the substrate 700 facing the second magnet 611 and the third magnet 631.

The substrate 700 may be mounted on side surfaces of the housing 300, and the second coil 613 and the third coil 633 may directly face the second magnet 611 and the third magnet 631 through openings in the housing 300.

During the optical image stabilization, the third magnet 631 may be a moving member mounted on the aperture module 100, and the third coil 633 may be a fixed member fixed to the housing 300.

When power is applied to the third coil 633, the aperture module 100 and the lens module 200 may move in the second axis (Y-axis) direction in response to an electromagnetic force generated between the third magnet 631 and the third coil 633.

The third magnet 631 and the third coil 633 may generate a driving force in the direction in which they face each other (e.g., the second axis (Y-axis) direction).

The second magnet 611 and the third magnet 631 may be disposed perpendicularly to each other in a plane perpendicular to the optical axis (Z-axis), and the second coil 613 and the third coil 633 may also be disposed perpendicularly to each other in a plane perpendicular to the optical axis (Z-axis).

Generally, in the prior art, magnets for the optical image stabilization have been mounted on the lens module 200. In this case, it has been necessary to provide the lens module 200 with a lens holder on which to mount the magnets for the optical image stabilization.

However, in the embodiment, the second magnet 611 and the third magnet 631 of the optical image stabilization unit 600 may be coupled to the aperture module 100 so that a lens holder is not needed. Accordingly, a size and weight of the camera module 1 may be reduced.

The camera module 1 according to an embodiment may include a second ball member B2 supporting the aperture module 100. The second ball member B2 may function to guide movement of the aperture module 100 during the optical image stabilization, and may also function to maintain a predetermined distance between the aperture module 100 and the carrier 400.

The second ball member B2 may guide the movement of the aperture module 100 in the first axis (X-axis) direction and in the second axis (Y-axis) direction.

As an example, the second ball member B2 may roll in the first axis (X-axis) direction when a driving force in the first axis (X-axis) direction is generated. Accordingly, the second ball member B2 may guide the movement of the aperture module 100 in the first axis (X-axis) direction.

The second ball member B2 may roll in the second axis (Y-axis) direction when a driving force in the second axis (Y-axis) direction is generated. Accordingly, the second ball member B2 may guide the movement of the aperture module 100 in the second axis (Y-axis) direction.

The second ball member B2 may include a plurality of ball members disposed between the aperture module 100 and the carrier 400. For example, the second ball member B2 may include four ball members.

A second guide groove 402 accommodating the second ball member B2 may be formed in either one or both of a surface of the aperture module 100 and a surface of the carrier 400 facing each other in the optical axis (Z-axis) direction. The second guide groove 402 may include a plurality of guide grooves corresponding to the plurality of ball members of the second ball member B2.

The second ball member B2 may be accommodated in the second guide groove 402 and may be inserted into a region between the aperture module 100 and the carrier 400.

A size of the second guide groove 402 may be greater than a diameter of the second ball member B2. A planar shape of the second guide groove 402 may be circular or polygonal.

In an embodiment, the camera module 1 may sense a position of the aperture module 100 in a direction perpendicular to the optical axis (Z-axis).

To this end, a second position sensor 615 and a third position sensor 635 may be provided. The second position sensor 615 may be disposed on the substrate 700 facing the second magnet 611, and the third position sensor 635 may be disposed on the substrate 700 facing the third magnet 631. The second position sensor 615 and the third position sensor 635 may be Hall sensors.

Either one or both of the second position sensor 615 and the third position sensor 635 may include two Hall sensors. For example, the third position sensor 635 may include two Hall sensors disposed facing the third magnet 631.

Through the two Hall sensors facing the third magnet 631, whether the aperture module 100 rotates may be sensed. Since the third coil 633 includes two coils facing the third magnet 631, a rotational force applied to the aperture module 100 may be offset by controlling the two coils of the third coil 633.

In embodiments, a second yoke 421 and a third yoke 422 may be provided so that the aperture module 100 and the carrier 400 may held in contact with the second ball member B2.

The second yoke 421 and the third yoke 422 may be mounted on the carrier 400, and may be disposed facing the second magnet 611 and the third magnet 631 in the optical axis (Z-axis) direction.

Accordingly, an attractive force may be generated in the optical axis (Z-axis) direction between the second yoke 421 and the second magnet 611, and an attractive force may be generated in the optical axis (Z-axis) direction between the third yoke 422 and the third magnet 631.

Because the aperture module 100 is pressed in a direction toward the second yoke 421 and the third yoke 422 by attractive force generated between the second yoke 421 and the third yoke 422 and the attractive force generated between the second magnet 611 and the third magnet 631, the aperture module 100 may be held contact in with the second ball member B2.

The second yoke 421 and the third yoke 422 may be made of a material that generates an attractive force between the second magnet 611 and the third magnet 631. As an example, the second yoke 421 and the third yoke 422 may be made of magnetic material.

A stopper 430 may be coupled to the carrier 400. The stopper 430 may be coupled to the carrier 400 to cover at least a portion of an upper surface of the aperture module 100.

The stopper 430 may prevent the aperture module 100 from being separated from the carrier 400 due to an external shock.

Although not illustrated in FIG. 1, a buffer member having an elastic force may be coupled to an edge portion of the stopper 430.

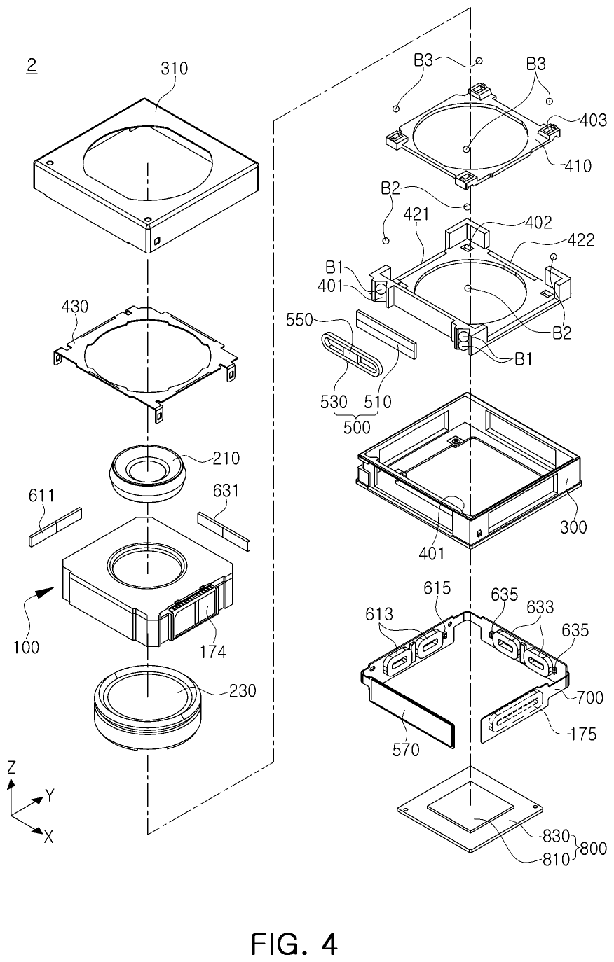

FIG. 4 is an exploded perspective diagram illustrating a camera module according to another embodiment of the present disclosure.

Referring to FIG. 4, as compared to the camera module 1 described with reference to FIGS. 1 to 3, a camera module 2 illustrated in FIG. 4 may further include a guide frame 410. The portion of the camera module 2 related to the guide frame 410 will be described with reference to FIG. 4.

The guide frame 410 may be disposed between the aperture module 100 and the carrier 400. The guide frame 410 may function to guide the aperture module 100 to move in a direction perpendicular to the optical axis (Z-axis) direction.

The guide frame 410 and the aperture module 100 may be stacked in order in the carrier 400. For example, the guide frame 410 may be disposed between the carrier 400 and the aperture module 100. The guide frame 410 may have a quadrangular plate shape having a central opening.

The guide frame 410 and the aperture module 100 may move together in one direction perpendicular to the optical axis (Z-axis) in response to one driving force generated by the optical image stabilization unit 600, and the aperture module 100 may move relative to the guide frame 410 in another direction perpendicular to the optical axis (Z-axis) in response to another driving force generated by the optical image stabilization unit 600.

For example, the guide frame 410 and the aperture module 100 may move together in the first axis (X-axis) direction perpendicular to the optical axis (Z-axis) in response to one driving force generated by the optical image stabilization unit 600 in the first axis (X-axis) direction, and the aperture module 100 may move relative to the guide frame 410 in the second axis (Y-axis) direction in response to another driving force generated by the optical image stabilization unit 600 in the second axis (Y-axis) direction.

The second ball member B2 may be disposed between the guide frame 410 and the carrier 400, and a third ball member B3 may be disposed between the aperture module 100 and the guide frame 410.

The second ball member B2 may guide movement of the aperture module 100 and the guide frame 410 in the first axis (X-axis) direction, and the third ball member B3 may guide movement of the aperture module 100 in the second axis (Y-axis) direction.

The second ball member B2 may include a plurality of ball members disposed between the guide frame 410 and the carrier 400, and the third ball member B3 may include a plurality of ball members disposed between the aperture module 100 and the guide frame 410.

For example, each of the second ball member B2 and the third ball member B3 may include four ball members.

A second guide groove 402 accommodating the second ball member B2 may be formed in either one or both of a surface of the guide frame 410 and a surface of the carrier 400 facing each other in the optical axis (Z-axis) direction.

The second ball member B2 may be accommodated in the second guide groove 402 and may be inserted into a region between the carrier 400 and the guide frame 410.

While the second ball member B2 is accommodated in the second guide groove 402, movement thereof in the optical axis (Z-axis) and the second axis (Y-axis) directions may be limited, and the second ball member B2 may move only in the first axis (X-axis) direction. For example, the second ball member B2 may roll only in the first axis (X-axis) direction.

To this end, a planar shape of the second guide groove 402 may be a rectangular shape having a length in the first axis (X-axis) direction.

A third guide groove 403 accommodating the third ball member B3 may be formed in either one or both of a surface the aperture module 100 and a surface of the guide frame 410 facing each other in the optical axis (Z-axis) direction.

The third ball member B3 may be accommodated in the third guide groove 403 and may be inserted into a region between the aperture module 100 and the guide frame 410.

While the third ball member B3 is accommodated in the third guide groove 403, movement thereof in the optical axis (Z-axis) and the first axis (X-axis) directions may be limited, and the third ball member B3 may move only in the second axis (Y-axis) direction. For example, the third ball member B3 may roll only in the second axis (Y-axis) direction.

To this end, a planar shape of the third guide groove 403 may be a rectangle having a length in the second axis (Y-axis) direction.

When a driving force is generated in the first axis (X-axis) direction, the aperture module 100 and the guide frame 410 may move together in the first axis (X-axis) direction.

In this case, the second ball member B2 may roll only along the first axis (X-axis). In this case, movement of the third ball member B3 may be limited.

Also, when a driving force is generated in the second axis (Y-axis) direction, the aperture module 100 may move relative to the guide frame 410 in the second axis (Y-axis) direction.

In this case, the third ball member B3 may roll only along the second axis (Y-axis). In this case, movement of the second ball member B2 may be limited.

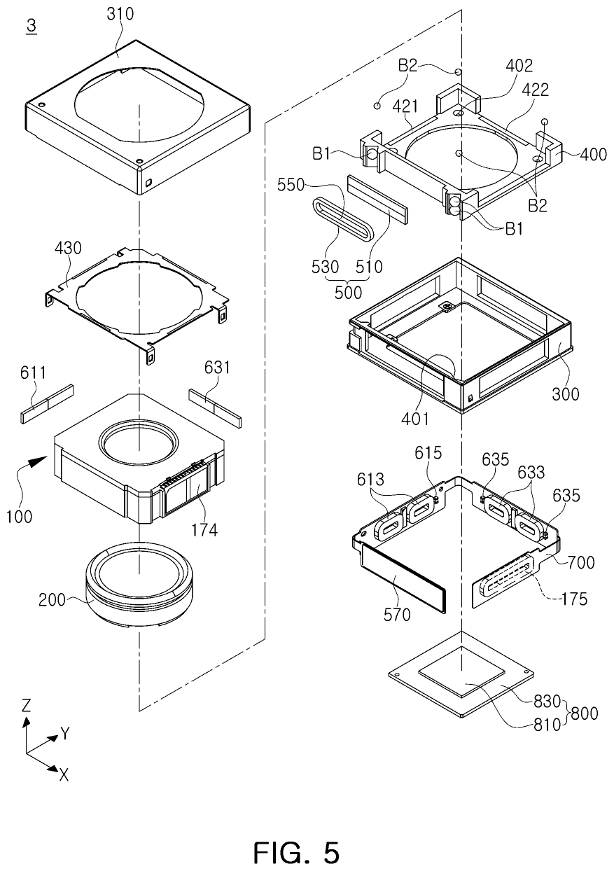

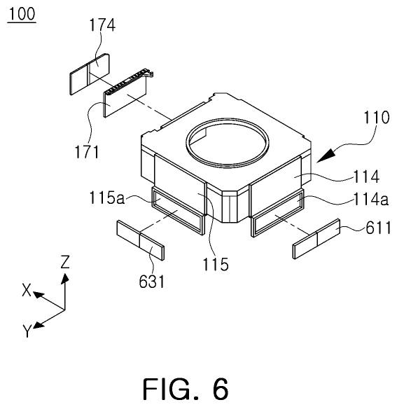

FIG. 5 is an exploded perspective diagram illustrating a camera module according to another embodiment of the present disclosure. FIG. 6 is a perspective diagram illustrating an aperture module of the camera module of FIG. 5.

Referring to FIG. 5, as compared to the camera module 1 described with reference to FIGS. 1 to 3, the camera module 3 illustrated in FIG. 5 may have differences with respect to the lens module 200, the aperture module 100, and the optical image stabilization unit 600. Portions of the camera module 3 related to the lens module 200, the aperture module 100, and the optical image stabilization unit 600 will be described with reference to FIG. 5.

The lens module 200 may be disposed in the aperture module 100. For example, the lens module 200 may be disposed in an internal space of the base 110 of the aperture module 100.

That is, the aperture module 100 may be disposed in front of the lens module 200.

Also, the second magnet 611 and the third magnet 631 may be disposed on the aperture module 100. For example, the second magnet 611 and the third magnet 631 may be disposed on the base 110 of the aperture module 100.

A bottom surface of the second magnet 611 and a bottom surface of the third magnet 631 may be disposed at positions lower than a bottom surface of the aperture magnet 174 in the optical axis (Z-axis) direction.

To this end, a first extension portion 114a extending in the optical axis (Z-axis) direction may be attached to the second sidewall 114 of the base 110, and a second extension portion 115a extending in the optical axis (Z-axis) direction may be attached to the third sidewall 115 of the base 110.

The second magnet 611 may be disposed on the first extension portion 114a, and the third magnet 631 may be disposed on the second extension portion 115a.

Referring to FIG. 5, since the aperture module 100 is disposed in front of the lens module 200, as compared to camera module 1 in FIGS. 1 to 3, the second magnet 611 and the third magnet 631 mounted on the aperture module 100 may need to be disposed at lower positions in the optical axis (Z-axis) direction.

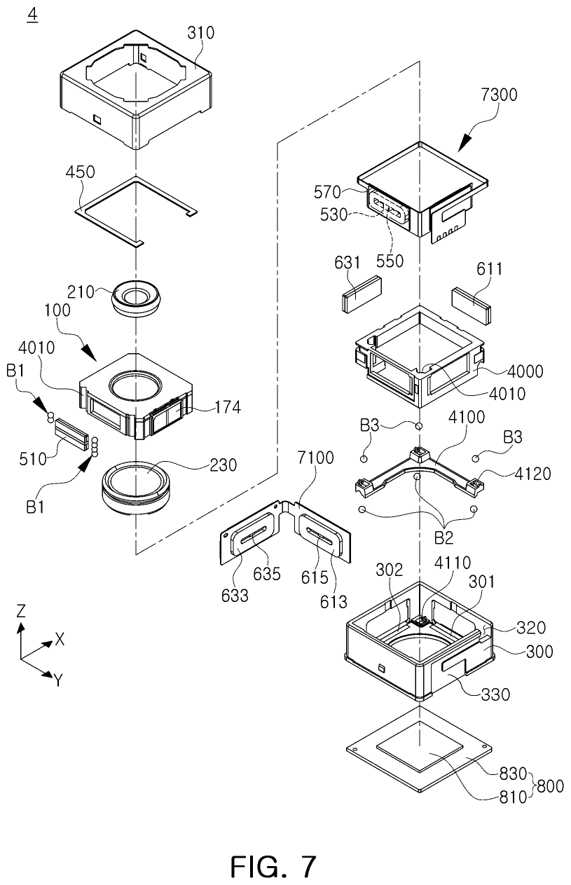

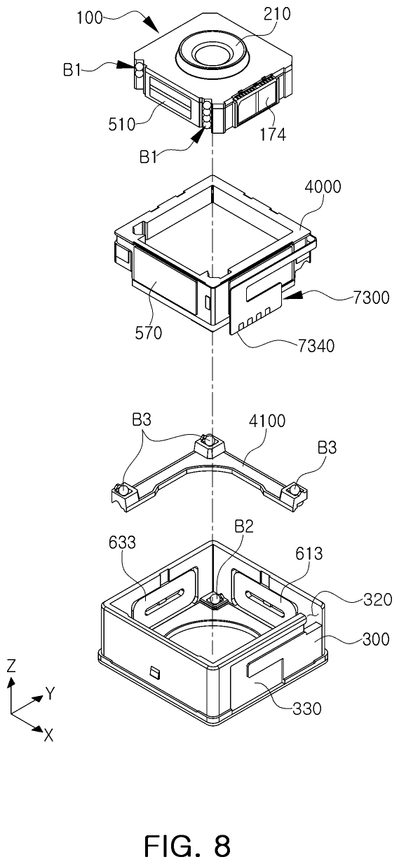

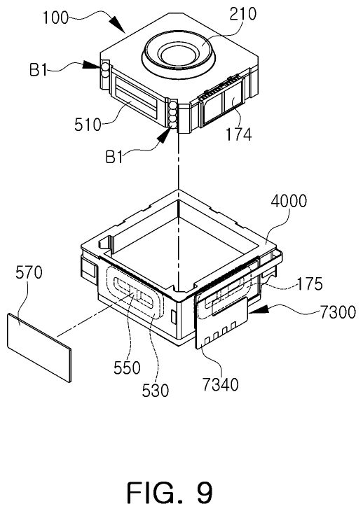

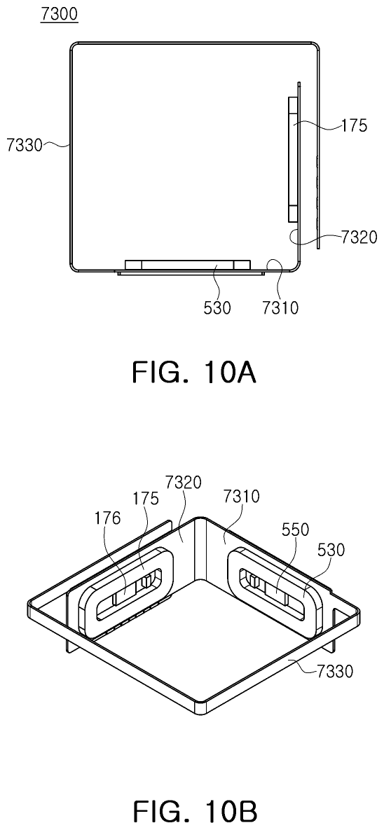

FIG. 7 is an exploded perspective diagram illustrating a camera module according to another embodiment of the present disclosure. FIG. 8 is a perspective diagram illustrating a portion of the camera module of FIG. 7. FIG. 9 is a perspective diagram illustrating an aperture module and an OIS carrier of FIGS. 7 and 8. FIG. 10A is a plan diagram illustrating a first substrate of FIGS. 7 to 9. FIG. 10B is a perspective diagram illustrating the first substrate of FIGS. 7 to 9.

Referring to FIGS. 7 to 10, a camera module 4 according to another embodiment may include an aperture module 100, a lens module 200, and a housing 300.

The aperture module 100 may be disposed in the housing 300 and may control the amount of light incident to the camera module 4.

The lens module 200 may be coupled to the aperture module 100. The lens module 200 may include a first lens unit 210 and a second lens unit 230 spaced apart from each other in the optical axis (Z-axis) direction. The first lens unit 210 may include one or more lenses, and the second lens unit 230 may include a plurality of lenses.

The aperture module 100 may be disposed between the first lens unit 210 and the second lens unit 230. For example, the first lens unit 210 may be coupled to an upper portion of the aperture module 100, and the second lens unit 230 may be coupled to a lower portion of the aperture module 100.

The aperture module 100 and the lens module 200 may be coupled to each other and may move together.

That is, the aperture module 100 and the lens module 200 may move together in the optical axis (Z-axis) direction for focus adjustment. Also, the aperture module 100 and the lens module 200 may move together in a direction perpendicular to the optical axis (Z-axis) for optical image stabilization.

The camera module 4 may further include an OIS carrier 4000, a guide frame 4100, a case 310, and an image sensor module 800.

The OIS carrier 4000 and the guide frame 4100 may be disposed in the housing 300, and may move relative to the housing 300 in a direction perpendicular to the optical axis (Z-axis) direction.

The housing 300 may have a shape in which an upper portion and a lower portion are open, an OIS carrier 4000 and a guide frame 4100 may be disposed in an internal space of housing 300, and an aperture module 100 and a lens module 200 may be accommodated in the OIS carrier 4000.

The OIS carrier 4000, the lens module 200 and the aperture module 100 may move together in a direction perpendicular to the optical axis (Z-axis) direction. Accordingly, shaking during imaging may be corrected.

Also, the lens module 200 and the aperture module 100 may move together in the optical axis (Z-axis) direction in the OIS carrier 4000. Accordingly, a distance between the lens module 200 and the image sensor 810 may change to adjust a focus of the camera module 4.

The camera module 4 may include an actuator driving unit. The actuator driving unit may generate a driving force in one or more of the optical axis (Z-axis) direction, the first axis (X-axis) direction, and the second axis (Y-axis) direction. The actuator driving unit may include one or more magnets and one or more coils.

For example, the actuator driving unit may include a focus adjustment unit 500 generating a driving force in the optical axis (Z-axis) direction, and an optical image stabilization unit 600 generating a driving force in a direction perpendicular to the optical axis (Z-axis) direction.

The image sensor module 800 may be a device converting incident light into an electrical signal through the lens module 200.

As an example, the image sensor module 800 may include an image sensor 810 and a printed circuit board 830 to which the image sensor 810 is connected, and may further include an infrared filter (not shown).

The infrared filter may block light in the infrared region of light incident through the lens module 200.

The image sensor 810 may convert incident light through the lens module 200 into an electrical signal. As an example, the image sensor 810 may be a charge-coupled device (CCD) or a complementary metal-oxide-semiconductor (CMOS) device.

The electrical signal converted by the image sensor 810 may be output as an image through a display unit of a portable electronic device in which the camera module 4 is mounted.

The image sensor 810 may be fixed to the printed circuit board 830 and may be electrically connected to the printed circuit board 830 by wire bonding.

The image sensor module 800 may be disposed in a lower portion of the housing 300.

The case 310 may be coupled to the housing 300 to surround an external surface of housing 300, and may function to protect internal components of the camera module 4.

The focus adjustment unit 500 may move the aperture module 100 and the lens module 200 to focus on a subject. For example, the focus adjustment unit 500 may move the aperture module 100 by generating a driving force in the optical axis (Z-axis) direction. Since the aperture module 100 is coupled to the lens module 200, the aperture module 100 and the lens module 200 may move together in the optical axis (Z-axis) direction in response to the driving force generated by the focus adjustment unit 500.

The focus adjustment unit 500 may include a first magnet 510 and a first coil 530. The first magnet 510 and first coil 530 may be disposed facing each other in a direction perpendicular to the optical axis (Z-axis).

One of the first magnet 510 and the first coil 530 may be disposed on the aperture module 100, and the other one of the first magnet 510 and the first coil 530 may be disposed on the OIS carrier 4000. In the description below, an embodiment in which the first magnet 510 is disposed on the aperture module 100 may be described.

The first magnet 510 may be mounted on the aperture module 100. As an example, the first magnet 510 may be mounted on one side surface of the base 110 of the aperture module 100.

The first magnet 510 may be magnetized so that one surface (e.g., the surface facing the first coil 530) may have both an N-pole and an S-pole. For example, the one surface of the first magnet 510 facing the first coil 530 may include an N-pole, a neutral region, and an S-pole sequentially arranged in the optical axis (Z-axis) direction.

The first coil 530 may be disposed facing the first magnet 510. For example, the first coil 530 may be disposed facing the first magnet 510 in a direction perpendicular to the optical axis (Z-axis).

The first coil 530 may be disposed on a first substrate 7300, and the first substrate 7300 may be mounted on the OIS carrier 4000 so that the first magnet 510 and the first coil 530 may face each other in a direction perpendicular to the optical axis (Z-axis). As an example, the first coil 530 may be disposed on one surface of the first substrate 7300. The first substrate 7300 may be mounted on a side surface of the OIS carrier 4000 so that the first magnet 510 and the first coil 530 may face each other in a direction perpendicular to the optical axis (Z-axis).

The OIS carrier 4000 may include an opening penetrating a side surface of the OIS carrier 4000, and the first coil 530 disposed on the first substrate 7300 may directly face the first magnet 510 through the opening.

The first magnet 510 may be a moving member mounted on the aperture module 100 and moving in the optical axis (Z-axis) direction together with the aperture module 100, and the first coil 530 may be a fixed member fixed to the first substrate 7300.

When power is applied to the first coil 530, the aperture module 100 may move in the optical axis (Z-axis) direction in response to an electromagnetic force generated between the first magnet 510 and the first coil 530.

Since the aperture module 100 is coupled to the lens module 200, the lens module 200 may also move in the optical axis (Z-axis) direction together with the aperture module 100.

Generally, in the prior art, a magnet for focus adjustment may be mounted on an autofocus (AF) carrier. However, in the embodiment, the first magnet 510 of the focus adjustment unit 500 may be mounted on the aperture module 100, so that an extra component such as an AF carrier is not needed. Accordingly, a size and a weight of the camera module 4 may be reduced.

A first ball member B1 may be disposed between the aperture module 100 and the OIS carrier 4000. For example, the first ball member B1 may be disposed between the aperture module 100 and the carrier to reduce friction when the aperture module 100 moves in the optical axis (Z-axis) direction.

The first ball member B1 may include a plurality of balls disposed in the optical axis (Z-axis) direction. The plurality of balls may roll in the optical axis (Z-axis) direction when the aperture module 100 moves in the optical axis (Z-axis) direction.

A first yoke 570 may be disposed on the housing 300. The first yoke 570 may be disposed at a position facing the first magnet 510. For example, the first coil 530 may be disposed on one surface of the first substrate 7300, and the first yoke 570 may be disposed on the other surface of the first substrate 7300.

The first magnet 510 and the first yoke 570 may generate an attractive force therebetween. For example, the first yoke 570 may be made of a magnetic material. An attractive force may act between the first magnet 510 and the first yoke 570 in a direction perpendicular to the optical axis (Z-axis).

The first ball member B1 may be held in contact with each of the aperture module 100 and the OIS carrier 4000 by the attractive force acting between the first magnet 510 and the first yoke 570.

A first guide groove 4010 may be formed in each of the aperture module 100 and the OIS carrier 4000.

For example, the first guide groove 4010 may be formed in surfaces of the OIS carrier 4000 and the base 110 of the aperture module 100 facing each other.

The first guide groove 4010 may extend in the optical axis (Z-axis) direction. The first ball member B1 may be disposed in the first guide groove 4010.

The first ball member B1 may include a first ball group and a second ball group. The first ball group and the second ball group may be spaced apart from each other in a direction perpendicular to the optical axis (Z-axis) (e.g., the Y-axis direction). The first ball group may include a plurality of balls disposed in the optical axis (Z-axis) direction. The number of balls included in the second ball group may be different from the number of balls included in the first ball group.

For example, the first ball group may include two or more balls disposed in the optical axis (Z-axis) direction, and the second ball group may include fewer balls than the number of balls included in the first ball group. The number of balls in each ball member may change as long as the number of balls in the first ball group and the number of balls in the second ball group are different.

In an embodiment, the camera module 4 may sense a position of the aperture module 100 in the optical axis (Z-axis) direction.

To this end, a first position sensor 550 may be provided. The first position sensor 550 may be disposed on the first substrate 7300 facing the first magnet 510. The first position sensor 550 may be a Hall sensor.

The camera module 4 may correct shaking during imaging by moving the OIS carrier 4000 in a direction perpendicular to the optical axis (Z-axis). To this end, the camera module 4 may include an optical image stabilization unit 600 configured to move the OIS carrier 4000 in a direction perpendicular to the optical axis (Z-axis).

The guide frame 4100 and the OIS carrier 4000 may be stacked in order in the housing 300. For example, the guide frame 4100 may be disposed between the OIS carrier 4000 and the housing 300. When viewed in the optical axis (Z-axis) direction, the guide frame 4100 may have a shape in which two sides of a quadrangular shape are removed. For example, the guide frame 4100 may have a ‘┐’ shape or a ‘└’ shape when viewed in the optical axis (Z-axis) direction.

In response to driving forces generated by the optical image stabilization unit 600, the guide frame 4100 and the OIS carrier 4000 may move together in one direction perpendicular to the optical axis (Z-axis), and the OIS carrier 4000 may move relative to the guide frame 4100 in another direction perpendicular to the optical axis (Z-axis).

For example, the guide frame 4100 and the OIS carrier 4000 may move together in the first axis (X-axis) direction perpendicular to the optical axis (Z-axis), and the OIS carrier 4000 may be moved relative to the guide frame 4100 in the second axis (Y-axis) direction.

Since the aperture module 100 and the lens module 200 are disposed in the OIS carrier 4000, the aperture module 100 and the lens module 200 may move together with the OIS carrier 4000.

For example, the OIS carrier 4000, the aperture module 100 and lens module 200 may move together in the first axis (X-axis) direction and the second axis (Y-axis) direction.

The optical image stabilization unit 600 may include a first sub-driving unit 610 and a second sub-driving unit 630. The first sub-driving unit 610 may generate a driving force in the first axis (X-axis) direction, and the second sub-driving unit 630 may generate a driving force in the second axis (Y-axis) direction.

The first sub-driving unit 610 may include a second magnet 611 and a second coil 613. The second magnet 611 and the second coil 613 may be disposed facing each other in the first axis (X-axis) direction.

One of the second magnet 611 and the second coil 613 may be disposed on the OIS carrier 4000, and the other one of the second magnet 611 and the second coil 613 may be disposed on the housing 300. In the description below, an embodiment in which the second magnet 611 is disposed on the OIS carrier 4000 will be described.

The second magnet 611 may be disposed on the OIS carrier 4000. For example, the second magnet 611 may be mounted on one side surface of the OIS carrier 4000.

The second magnet 611 may be magnetized so that one surface of the second magnet 611 may have an N-pole or an S-pole. The second magnet 611 may have a shape having a length in the second axis (Y-axis) direction.

The other surface of the second magnet 611 may be magnetized to have a polarity opposite to the polarity of the one surface of the second magnet 611. For example, if the one surface of the second magnet 611 has an N-pole, the other surface of the second magnet 611 may have an S-pole. Alternatively, if the one surface of the second magnet 611 has an S-pole, the other surface of the second magnet 611 may have an N-pole.

The second coil 613 may be disposed facing the second magnet 611. For example, the second coil 613 may be disposed facing the second magnet 611 in the first axis (X-axis) direction.

The second coil 613 may include a coil and may have a toroid shape having a central opening.

During optical image stabilization, the second magnet 611 may be a moving member mounted on the OIS carrier 4000, and the second coil 613 may be a fixed member fixed to the housing 300.

When power is applied to the second coil 613, the OIS carrier 4000 and the guide frame 4100 may move in the first axis (X-axis) direction in response to an electromagnetic force generated between the second magnet 611 and the second coil 613.

The second magnet 611 and the second coil 613 may generate a driving force in the direction in which they face each other (e.g., the first axis (X-axis) direction).

The second sub-driving unit 630 may include a third magnet 631 and a third coil 633. The third magnet 631 and the third coil 633 may be disposed facing each other in the second axis (Y-axis) direction.

One of the third magnet 631 and the third coil 633 may be disposed on the OIS carrier 4000, and the other one of the third magnet 631 and the third coil 633 may be disposed on the housing 300. In the description below, an embodiment in which the third magnet 631 is disposed on the OIS carrier 4000 will be described.

The third magnet 631 may be disposed on the OIS carrier 4000. For example, the third magnet 631 may be mounted on the another side surface of the OIS carrier 4000 adjacent to the one side surface of the OIS carrier on which the second magnet 611 is mounted.

The one side surface of the OIS carrier 4000 on which the second magnet 611 is mounted and the other side surface of the OIS carrier 4000 on which the third magnet 613 is mounted may be perpendicular to each other on a plane perpendicular to the optical axis (Z-axis).

The third magnet 631 may be magnetized so that one surface of the third magnet 631 may have an N-pole or an S-pole. The third magnet 631 may have a shape having a length in the first axis (X-axis) direction.

The other surface of the third magnet 631 may be magnetized to have a polarity opposite to the polarity of the one surface of the third magnet 631. For example, if the one surface of the third magnet 631 has an N-pole, the other surface of the third magnet 613 may have an S-pole. Alternatively, if the one surface of the third magnet 613 has an S-pole, the other surface of the third magnet 613 may have an N-pole.

The third coil 633 may be disposed facing the third magnet 631. For example, the third coil 633 may be disposed facing the third magnet 631 in the second axis (Y-axis) direction.

The third coil 633 may include a coil and may have a toroid shape having a central opening.

The second coil 613 and the third coil 633 may be disposed on a second substrate 7100. As an example, the second coil 613 and the third coil 633 may be disposed on the second substrate 7100 facing the second magnet 611 and the third magnet 631.

The second substrate 7100 may be mounted on two side surfaces of the housing 300, and the second coil 613 and the third coil 633 may directly face the second magnet 611 and the third magnet 631 through two openings provided in the housing 300.

During optical image stabilization, the third magnet 631 may be a moving member mounted on the OIS carrier 4000, and the third coil 633 may be a fixed member fixed to the housing 300.

When power is applied to the third coil 633, the OIS carrier 4000 may move in the second axis (Y-axis) direction in response to an electromagnetic force generated between the third magnet 631 and the third coil 633.

The third magnet 631 and the third coil 633 may generate a driving force in a direction in which they face each other (e.g., the second axis (Y-axis) direction).

The second magnet 611 and the third magnet 631 may be disposed perpendicularly to each other on a plane perpendicular to the optical axis (Z-axis), and the second coil 613 and the third coil 633 may also be disposed perpendicularly to each other on a plane perpendicular to the optical axis (Z-axis).

The camera module 4 may include a plurality of ball members supporting the guide frame 4100 and the OIS carrier 4000. The plurality of ball members may function to guide movement of the guide frame 4100 and the OIS carrier 4000 during optical image stabilization, and may also function to maintain a predetermined distance between the housing 300 and the guide frame 4100, and a predetermined distance between the guide frame 4100 and the OIS carrier 4000.

The plurality of ball members may include a second ball member B2 and a third ball member B3.

The second ball member B2 may guide movement of the guide frame 4100 and the OIS carrier 4000 in the first axis (X-axis) direction, and the third ball member B3 may guide movement of the OIS carrier 4000 in the second axis (Y-axis) direction.

As an example, the second ball member B2 may roll in the first axis (X-axis) direction when a driving force is generated in the first axis (X-axis) direction. Accordingly, the second ball member B2 may guide movement of the guide frame 4100 and the OIS carrier 4000 in the first axis (X-axis) direction.

The third ball member B3 may roll in the second axis (Y-axis) direction when a driving force is generated in the second axis (Y-axis) direction. Accordingly, the third ball member B3 may guide movement of the OIS carrier 4000 in the second axis (Y-axis) direction.

The second ball member B2 may include a plurality of ball members disposed between the housing 300 and the guide frame 4100, and the third ball member B3 may include a plurality of ball members disposed between the guide frame 4100 and the OIS carrier 4000.

For example, each of the second ball member B2 and the third ball member B3 may include three ball members.

A second guide groove 4110 accommodating the second ball member B2 may be formed either one or both of a surface of the housing 300 and a surface of the guide frame 4100 facing each other in the optical axis (Z-axis) direction. The second guide groove 4110 may include a plurality of grooves corresponding to the plurality of ball members of each second ball member B2.

The second ball member B2 may be accommodated in the second guide groove 4110 and may be inserted into a region between the housing 300 and the guide frame 4100.

While the second ball member B2 is accommodated in the second guide groove 4110, movement of the second ball member B2 in the optical axis (Z-axis) direction and the second axis (Y-axis) direction may be limited, and the second ball member B2 may move only in the first axis (X-axis) direction. For example, the second ball member B2 may roll only in the first axis (X-axis) direction.

To this end, a planar shape of each of the plurality of grooves of the second guide groove 4110 may be a rectangle having a length in the first axis (X-axis) direction.

A third guide groove 4120 accommodating the third ball member B3 may be formed in one or both of a surface of the guide frame 4100 and a surface of the OIS carrier 4000 facing each other in the optical axis (Z-axis) direction. The third guide groove 4120 may include a plurality of grooves corresponding to the plurality of ball members of the third ball member B3.

The third ball member B3 may be accommodated in the third guide groove 4120 and may be inserted into a region between the guide frame 4100 and the OIS carrier 4000.

While the third ball member B3 is accommodated in the third guide groove 4120, movement of the third ball member B3 in the optical axis (Z-axis) direction and the first axis (X-axis) direction may be limited, and the third ball member B3 may move only in the second axis (Y-axis) direction. For example, the third ball member B3 may roll only in the second axis (Y-axis) direction.

To this end, a planar shape of each of plurality of grooves of the third guide groove 4120 may be a rectangle having a length in the second axis (Y-axis) direction.

When a driving force is generated in the first axis (X-axis) direction, the guide frame 4100 and the OIS carrier 4000 may move together in the first axis (X-axis) direction. Also, the aperture module 100 and the lens module 200 may also move in the first axis (X-axis) direction together with the OIS carrier 4000.

In this case, the second ball member B2 may roll along the first axis (X-axis), and movement of the third ball member B3 may be limited.

Also, when a driving force is generated in the second axis (Y-axis) direction, the OIS carrier 4000 may move relative to the guide frame 4100 in the second axis (Y-axis) direction.

Also, the aperture module 100 and the lens module 200 may also move in the second axis (Y-axis) direction together with the OIS carrier 4000.

In this case, the third ball member B3 may roll along the second axis (Y-axis), and movement of the second ball member B2 may be limited.

In an embodiment, the camera module 4 may sense a position of the aperture module 100 in a direction perpendicular to the optical axis (Z-axis).

To this end, a second position sensor 615 and a third position sensor 635 may be provided. The second position sensor 615 may be disposed on the second substrate 7100 facing the second magnet 611, and the third position sensor 635 may be disposed on the second substrate 7100 facing the third magnet 631. The second position sensor 615 and the third position sensor 635 may be Hall sensors.

In embodiments, a second yoke 301 and a third yoke 302 may be provided so that the housing 300 and the guide frame 4100 may be held in contact with the second ball member B2, and the guide frame 4100 and OIS carrier 4000 may be held in contact with the third ball member B3.

The second yoke 301 and the third yoke 302 may be fixed to the housing 300 and may be disposed facing the second magnet 611 and the third magnet 631 in the optical axis (Z-axis) direction.

Accordingly, attractive forces may be generated in the optical axis (Z-axis) direction between the second yoke 301 and the second magnet 611, and between the third yoke 302 and the third magnet 631.

Because the OIS carrier 4000 and the guide frame 4100 are pressed in a direction toward the second yoke 301 and the third yoke 302 by the attractive forces generated between the second yoke 301 and the second magnet 611, and between the third magnet 631 and the third yoke 302, the OIS carrier 4000 and the guide frame 4100 may be held in contact with the second ball member B2 and the third ball member B3.

The second yoke 301 and the third yoke 302 may be made of a material that may generate attractive forces with the second magnet 611 and the third magnet 631. As an example, the second yoke 301 and the third yoke 302 may be made of a magnetic material.

A stopper 450 may be coupled to the OIS carrier 4000. The stopper 450 may be coupled to the OIS carrier 4000 to cover at least a portion of an upper surface of the aperture module 100.

The stopper 450 may prevent the aperture module 100 from being separated from the OIS carrier 4000 due to an external shock.

Although not illustrated in FIG. 7, a buffer member having an elastic force may be coupled to an edge portion of the stopper 450.

An aperture driving unit may include an aperture magnet 174 and an aperture coil 175. The aperture magnet 174 may be disposed on the aperture module 100. The aperture coil 175 of the aperture driving unit 170, an aperture position sensor 176, and the first coil 530 of the focus adjustment unit 500 may be disposed on the first substrate 7300.

Since the first substrate 7300 is mounted on the OIS carrier 4000, the first substrate 7300 may move together with the OIS carrier 4000 during optical image stabilization. Since the first substrate 7300 moves during optical image stabilization, a component to stably supply power to the aperture coil 175 and the first coil 530 may be necessary.

To this end, the first substrate 7300 may include a first mounting unit 7310, a second mounting unit 7320, an extension portion 7330, and a fixed portion 7340. The first coil 530 may be disposed on the first mounting unit 7310, and the aperture coil 175 may be disposed on the second mounting unit 7320. The second mounting unit 7320 may be curved and extended from one end of the first mounting unit 7310.

The extension portion 7330 may be configured to connect the first mounting unit 7310 to the fixed portion 7340. For example, one end of the extension portion 7330 may be connected to the other end of the first mounting unit 7310, and the other end of the extension portion 7330 may be connected to the fixed portion 7340. The extension portion 7330 may have a bent shape, may be bent at least once, and may be made of a flexible material.

The fixed portion 7340 may be connected to the printed circuit board 830 and may supply power to the first substrate 7300.

The first mounting unit 7310 and the second mounting unit 7320 may be mounted on side surfaces of the OIS carrier 4000, and the fixed portion 7340 may be mounted on a side surface of the housing 300. Also, a first portion of the extension portion 7330 may extend along side surfaces of the OIS carrier 4000, and a second portion of the extension portion 7330 may be mounted on the side surface of the housing 300 on which the fixed portion 7340 is mounted.

That is, the second portion of the extension portion 7330 may be disposed on the housing 300, and the first portion of the extension portion 7330 may not be disposed on the housing 300.

A portion of the extension portion 7330 may be spaced apart from a side surface of the OIS carrier 4000 in a direction perpendicular to the optical axis (Z-axis).

A side surface of the housing 300 may include a through-hole 310 penetrating the side surface of the housing 300, and a recess 330 formed in the side surface of the housing 300. The second portion of the extension portion 7330 may extend outside the housing 300 through the through-hole 310 of the housing 300 and may be disposed in the recess 330. The fixed portion 7340 may also be disposed in the recess 330

When the OIS carrier 4000 moves, the extension portion 7330 of the first substrate 7300 may be bent.

Accordingly, even when the OIS carrier 4000 moves during optical image stabilization, the first substrate 7300 may stably supply power to the aperture coil 175 and the first coil 530.

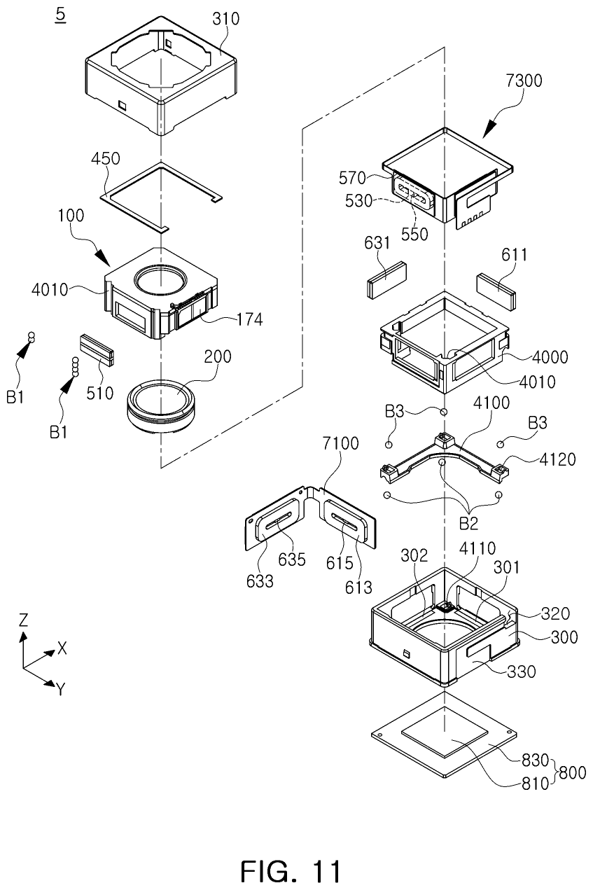

FIG. 11 is an exploded perspective diagram illustrating a camera module according to another embodiment of the present disclosure.

Referring to FIG. 11, as compared to camera module 4 illustrated with reference to FIGS. 7 to 10, a camera module 5 illustrated in FIG. 11 may be different with respect to the lens module 200 and the focus adjustment unit 500. Portions related to the lens module 200 and the focus adjustment unit 500 may be described with reference to FIG. 11.

The lens module 200 may be disposed in the aperture module 100. For example, the lens module 200 may be disposed in an internal space of the base 110 of the aperture module 100.

That is, the aperture module 100 may be disposed in front of the lens module 200.

Also, the first magnet 510 may be disposed in the aperture module 100. For example, the first magnet 510 may be disposed on the base 110 of the aperture module 100.

A bottom surface of the first magnet 510 may be disposed lower than a bottom surface of the aperture magnet 174 in the optical axis (Z-axis) direction.

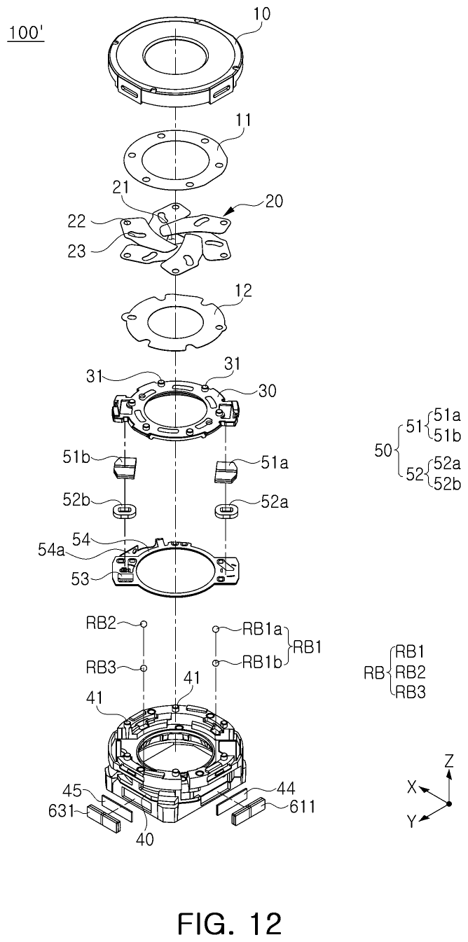

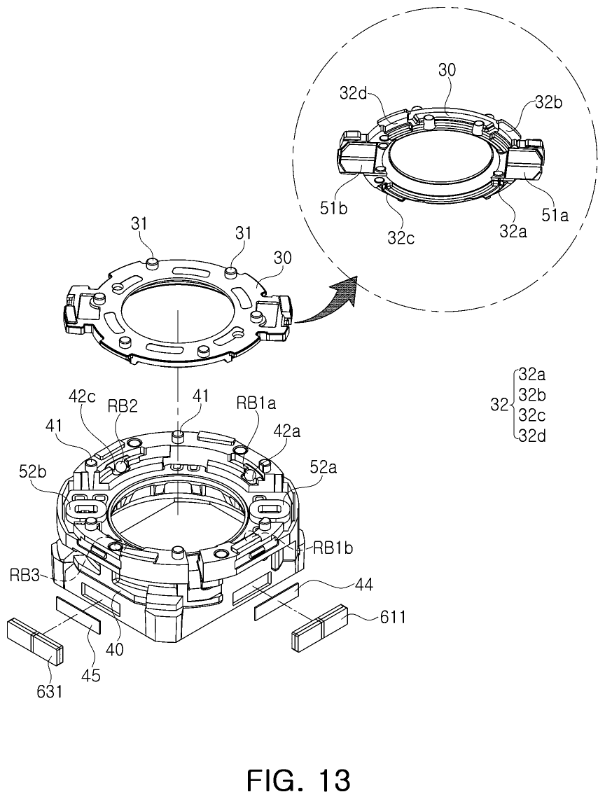

FIG. 12 is an exploded perspective diagram illustrating an aperture module according to another embodiment of the present disclosure. FIG. 13 is an exploded perspective diagram illustrating an example in which an aperture driving unit of the aperture module of FIG. 12 is disposed on a base and a rotating body of the aperture module of FIG. 12.

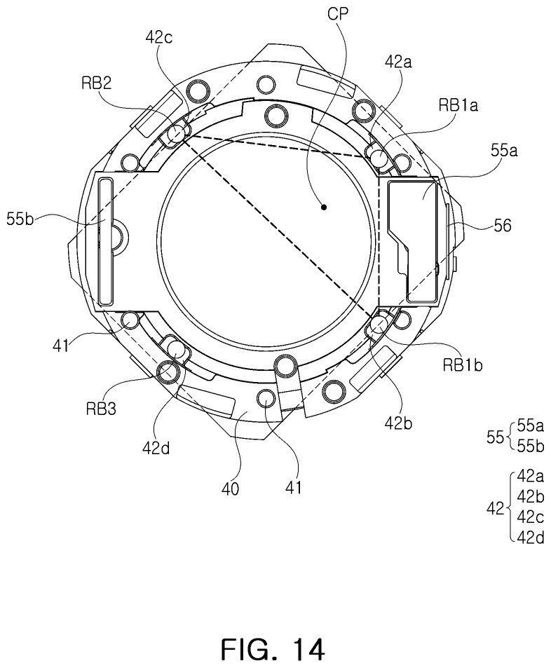

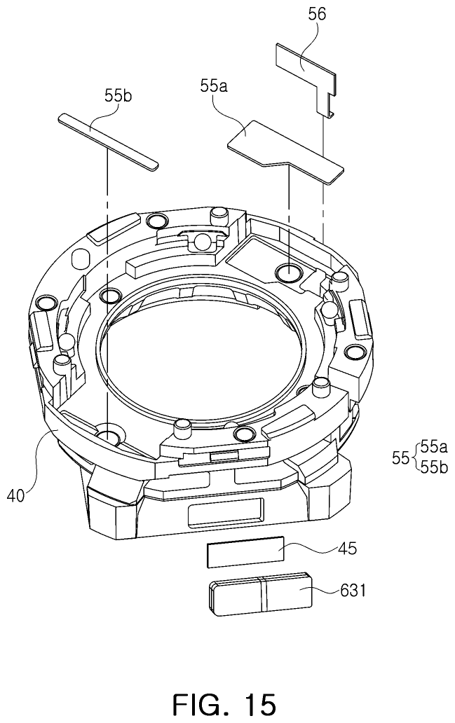

FIG. 14 is a plan diagram illustrating a state in which a rolling portion of the aperture module of FIG. 12 is disposed on the base. FIG. 15 is a perspective diagram illustrating a state in which a pulling yoke portion and an auxiliary yoke of the camera module of FIG. 12 are separated from the base.

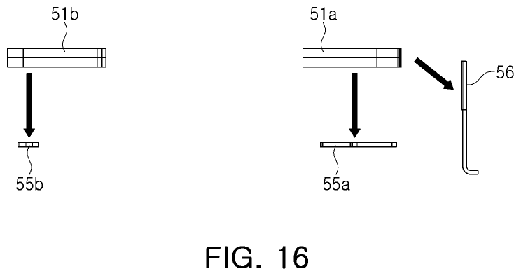

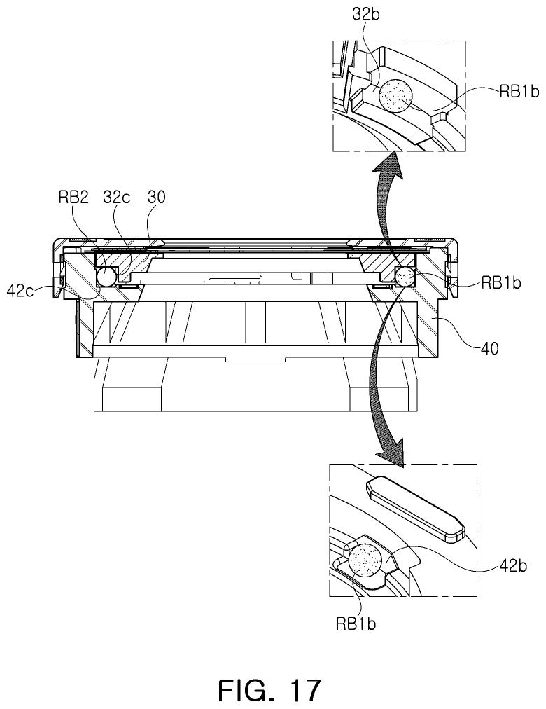

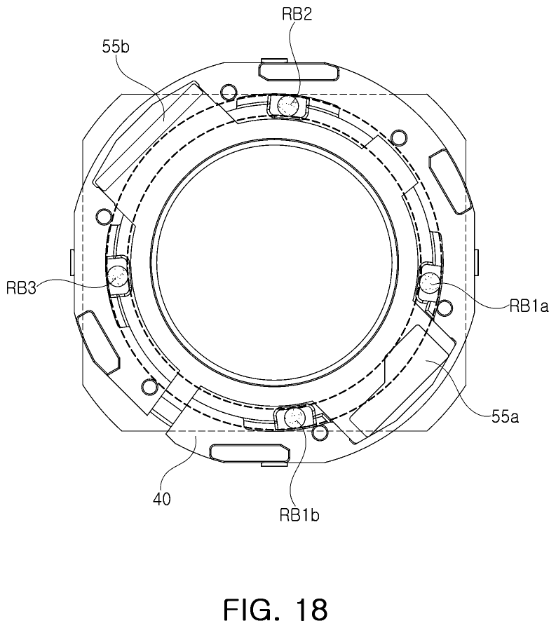

FIG. 16 is a diagram illustrating an arrangement of a magnet portion, a pulling yoke portion, and an auxiliary yoke of the camera module of FIG. 12 are viewed from the side. FIG. 17 is a cross-sectional diagram illustrating the aperture module of FIG. 12. FIG. 18 is a plan diagram illustrating a rolling portion of the aperture module of FIG. 12 disposed in a guide groove of the aperture module of FIG. 12.

An aperture module 100′ according to another embodiment will be described with reference to FIGS. 12 to 18.

The aperture module 100 in the aforementioned embodiments described with reference to FIGS. 1 to 11 may be replaced with the aperture module 100′ illustrated in FIGS. 12 to 18.

The aperture module 100′ may include a base 40, a rotating body 30, a plurality of blades 20, and an aperture driving unit 50.

The aperture module 100′ may further include a cover 10. The cover 10 may be coupled to the base 40. The plurality of blades 20 and the rotating body 30 may be disposed in a space between the cover 10 and the base 40.

The aperture module 100′ may be coupled to any of the lens modules 200 shown in FIGS. 1, 4, 5, 7, and 11.

In an embodiment, the lens module 200 may include a first lens unit 210 and a second lens unit 230 spaced apart from each other in the optical axis (Z-axis) direction. The aperture module 100′ may be disposed between the first lens unit 210 and the second lens unit 230. For example, the first lens unit 210 may be coupled to the cover 10 of aperture the module 100′, and the second lens unit 230 may be coupled to the base 40 of the aperture module 100′.

In an embodiment, the aperture module 100′ may be disposed in front of the lens module 200. The lens module 200 may be disposed in the aperture module 100′. For example, the lens module 200 may be disposed in an internal space of the base 40 of the aperture module 100′.

The aperture module 100′ and the lens module 200 may move together in the optical axis (Z-axis) direction for focus adjustment. For example, the aperture module 100 and the lens module 200 may move together in the optical axis (Z-axis) direction in response to a driving force generated by the focus adjustment unit 500.

The aperture module 100′ and the lens module 200 may move together in a direction perpendicular to the optical axis (Z-axis) for optical image stabilization. For example, the aperture module 100 and the lens module 200 may move together in the first axis (X-axis) direction and the second axis (Y-axis) direction in response to driving forces generated by the optical image stabilization unit 600.

A portion of the focus adjustment unit 500 or a portion of the optical image stabilization unit 600 may be disposed on the aperture module 100′.

In an embodiment, a portion of the optical image stabilization unit 600 may be disposed on the aperture module 100′.

Referring to FIGS. 12 and 13, the arrangement form of the optical image stabilization unit 600 may be similar to the embodiments described with reference to FIGS. 1 to 6.

For example, the second magnet 611 and the third magnet 631 of the optical image stabilization unit 600 may be disposed on the aperture module 100′. In other words, the second magnet 611 and the third magnet 631 may be disposed on sidewalls of the base 40 of the aperture module 100′. The second magnet 611 and the third magnet 631 may be disposed perpendicular to each other.

Also, back yokes 44 and 45 may be disposed between a sidewall of the base 40 and the second magnet 611 and the third magnet 631. For example, the back yoke 44 may be disposed between one sidewall of the base 40 and the second magnet 611, and the back yoke 45 may be disposed between another sidewall of the base 40 and the third magnet 631.

The back yokes 44 and 45 may be made of a magnetic material. Accordingly, magnetic fields of the second magnet 611 and the third magnet 631 may be prevented from leaking, and magnetic field interference with the aperture driving unit 50 may be prevented.

In an embodiment, a portion of the focus adjustment unit 500 may be disposed on the aperture module 100′. Although not illustrated in FIGS. 12 to 18, the arrangement of the focus adjustment unit 500 may be similar to the embodiments described with reference to FIGS. 7 to 11.

For example, the first magnet 510 of the focus adjustment unit 500 may be disposed on the aperture module 100′. In other words, the first magnet 510 may be disposed on one sidewall of the aperture module 100′. A back yoke (not shown may be disposed between the one sidewall of the aperture module 100′ and the first magnet 510.

The rotating body 30 may rotate relative to the base 40. For example, the rotating body 30 may be spaced apart from the base 40 in the optical axis (Z-axis) direction and may rotate relative to the base 40. As the rotating body 30 rotates, a size of an entrance hole 21 of the aperture module 100′ may change.

The plurality of blades 20 may form an entrance hole 21. The blades may be disposed so that a portion of a blade may overlap another blade in the optical axis (Z-axis) direction. For example, one set of a plurality of blades (e.g., three blades) and another set of a plurality of blades (e.g., three blades) may be stacked in order in the optical axis (Z-axis) direction. A portion of each blade may overlap other two blades in the optical axis (Z-axis) direction.

In the embodiment, six blades may be provided, three blades may form one set, and two sets of blades may be stacked in two layers, but the number of the plurality of blades 20 is not limited thereto.

An entrance hole 21 may be defined by surfaces of each blade facing the optical axis (Z-axis). A position of each blade may be changed by the aperture driving unit 50. Accordingly, a size of the entrance hole 21 may change depending on a position of each blade.

For example, a size of the entrance hole 21 may decrease or increase by rotating each blade.

The plurality of blades 20 may be coupled to the base 40 and the rotating body 30. Since each blade may have the same shape, one blade may be described below.

The blade may include a through-hole 22. For example, the blade may have a through-hole 22 in an outside end of the blade, and the through-hole 22 may have a shape penetrating the blade in the optical axis (Z-axis) direction.

The through-hole 22 of the blade may be coupled to the base 40. For example, a protrusion 41 protruding in the optical axis (Z-axis) direction may be disposed on the base 40, and the protrusion 41 may be coupled to the through-hole 22 of the blade. A plurality of the protrusions 41 equal in number to the plurality of blades 20 may be provided.

The protrusion 41 may form a rotating shaft of the blade. The protrusion 41 and the through-hole 22 may have corresponding sizes.

Also, the blade may include a guide hole 23. For example, the blade may have a guide hole 23 spaced apart from the through-hole 22.

The guide hole 23 of the blade may be coupled to the rotating body 30. For example, a guide protrusion 31 protruding in the optical axis (Z-axis) direction may be disposed on the rotating body 30, and the guide protrusion 31 may be coupled to the guide hole 23 of the blade. A plurality of the guide protrusions 31 equal in number to the plurality of blades 20 may be provided.

The guide hole 23 may have a size greater than a size of the guide protrusion 31. For example, a width of the guide hole 23 may correspond to a diameter of the guide protrusion 31, and a length of the guide hole 23 may be greater than a diameter of the guide protrusion 31.

The shape of guide hole 23 is not limited to the shape shown in FIG. 12. For example, as long as the position of the blade may move in conjunction with movement of the rotating body 30, the shape of the guide hole 23 may be changed.

Accordingly, as the rotating body 30 rotates, the guide protrusion 31 may move in the guide hole 23, and accordingly, the blade may rotate using the protrusion 41 of the base 40 as a rotating shaft.

A first spacer 11 may be disposed between the plurality of blades 20 and the cover 10. For example, the first spacer 11 may be coupled to the rotating body 30 and disposed between the plurality of blades 20 and the cover 10. The first spacer 11 may cover at least a portion of upper surfaces of the plurality of blades 20. The surface of the first spacer 11 may be coated black.

The first spacer 11 may have a through-hole through which light passes, and a size of the through-hole of the first spacer 11 may be greater than a maximum size of the entrance hole 21 formed by the plurality of blades 20.

A second spacer 12 may be disposed between the rotating body 30 and the plurality of blades 20. For example, the second spacer 12 may be coupled to the rotating body 30 and disposed between the rotating body 30 and the plurality of blades 20. The second spacer 12 may cover at least a portion of lower surfaces of the plurality of blades 20. The surface of the second spacer 12 may be coated black.

The second spacer 12 may have a through-hole through which light passes, and a size of the through-hole of the second spacer 12 may be greater than a maximum size of the entrance hole 21 formed by the plurality of blades 20. Also, the size of the through-hole of the second spacer 12 may be smaller than the size of the through-hole of the first spacer 11.

The aperture driving unit 50 may move the rotating body 30 to change the size of the entrance hole 21. For example, the aperture driving unit 50 may generate a driving force to rotate the rotating body 30.

As the rotating body 30 rotates, the guide protrusion 31 of the rotating body 30 may move in the guide hole 23 of the plurality of blades 20, and accordingly the plurality of blades 20 may rotate using the protrusion 41 of the base 40 as a rotating shaft and the size of the entrance hole 21 may change.

The aperture driving unit 50 may include a magnet portion 51 and a coil portion 52. The magnet portion 51 and the coil portion 52 may be disposed facing each other in the optical axis (Z-axis) direction.

The magnet portion 51 may be disposed on one of the rotating body 30 and the base 40, and the coil portion 52 may be disposed on the other one of the rotating body 30 and the base 40.

For example, the magnet portion 51 may be mounted on the rotating body 30. As an example, the magnet portion 51 may be mounted on a lower surface of the rotating body 30.

The magnet portion 51 may include a plurality of aperture magnets spaced apart from each other. As an example, the magnet portion 51 may include a first aperture magnet 51a and a second aperture magnet 51b disposed on opposite sides of the optical axis (Z-axis).

The first and second aperture magnets 51a and 51b may be magnetized so that one surface (e.g., the surface facing the coil portion 52) may have both N- and S-poles. For example, the one surface of the first and second aperture magnets 51a and 51b facing the coil portion 52 may include an N-pole, a neutral region, and an S-pole sequentially arranged in a direction (e.g., the direction of rotation of the rotating body 30) perpendicular to the optical axis (Z-axis).

The coil portion 52 may be disposed facing the magnet portion 51. For example, the coil portion 52 may be disposed facing the magnet portion 51 in the optical axis (Z-axis) direction.

The coil portion 52 may be disposed on an aperture substrate 54, and the aperture substrate 54 may be mounted on the base 40 so that the magnet portion 51 and the coil portion 52 may face each other in the optical axis (Z-axis) direction. As an example, the coil portion 52 may be disposed on one surface of the aperture substrate 54. The aperture substrate 54 may be mounted on an upper surface of the base 40.

Also, the aperture substrate 54 may include a first extension portion 54a extending from an upper surface of the base 40 to a side surface of the base 40. The first extension portion 54a may be electrically connected to the printed circuit board 830. A connection substrate, at least a portion of which is flexible, may be disposed between the first extension portion 54a and the printed circuit board 830.

The coil portion 52 may include a plurality of aperture coils. As an example, the coil portion 52 may include a first aperture coil 52a and a second aperture coil 52b disposed on opposite sides of the optical axis (Z-axis).

When a size of the entrance hole 21 changes, the magnet portion 51 may be a moving member mounted on the rotating body 30 and rotating with the rotating body 30, and the coil portion 52 may be a fixed member fixed to the base 40.

In another embodiment, the magnet portion 51 and the coil portion 52 may be disposed opposite to each other. In this case, since the coil portion 52 and the aperture substrate 54 are mounted on the rotating body 30 and rotate together with the rotating body 30, at least a portion of the aperture substrate 54 may be configured to be flexible.

When power is applied to the coil portion 52, the rotating body 30 may rotate in response to an electromagnetic force generated between the magnet portion 51 and the coil portion 52.

In the embodiment, a portion of the aperture driving unit 50, for example, the magnet portion 51, may rotate to rotate the rotating body 30.

A rolling portion RB may be disposed between the base 40 and the rotating body 30. For example, the rolling portion RB may be disposed between the base 40 and the rotating body 30 and may reduce friction when the rotating body 30 rotates.

The rolling portion RB may include a plurality of rolling balls spaced apart from each other in a circumferential direction of the rotating body 30. When the rotating body 30 rotates, the plurality of rolling balls may roll in the direction of rotation of the rotating body 30. The rolling portion RB may include three or more rolling balls. In the embodiment, the rolling portion RB may include four rolling balls, but the number of plurality of rolling balls is not limited as long as the number of balls is three or more.

A pulling yoke portion 55 may be disposed on the base 40. The pulling yoke portion 55 may be disposed facing the magnet portion 51 in the optical axis (Z-axis) direction.

The pulling yoke portion 55 may be integrally coupled with the base 40 by insert injection molding. In this case, the pulling yoke portion 55 may be integrated with the base 40 during manufacturing by injecting a resin material into a mold in which the pulling yoke portion 55 has been inserted.

The pulling yoke portion 55 and the magnet portion 51 may generate an attractive force therebetween. For example, the pulling yoke portion 55 may be made of a magnetic material. An attractive force may act between the magnet portion 51 and the pulling yoke portion 55 in the direction of the optical axis (Z-axis).

By the attractive force of the magnet portion 51 and the pulling yoke portion 55, the rolling portion RB may be held in contact with each of the base 40 and the rotating body 30.

The pulling yoke portion 55 may include a first pulling yoke 55a and a second pulling yoke 55b. The first pulling yoke 55a may face the first aperture magnet 51a in the optical axis (Z-axis) direction, and the second pulling yoke 55b may face the second aperture magnet 51b in the optical axis (Z-axis) direction.

The rolling portion RB may include a first rolling member RB1 and a second rolling member RB2, and may further include a third rolling member RB3. The first to third rolling members RB1, RB2, and RB3 may be spaced apart from each other in the circumferential direction of the base 40.

Each of the first to third rolling members RB1, RB2, and RB3 may include one or more rolling balls.

The number of rolling balls included in the first rolling member RB1 may be greater than the number of rolling balls included in the second rolling member RB2. Also, the number of rolling balls included in the first rolling member RB1 may be greater than the number of rolling balls included in the third rolling member RB3.

In an embodiment, the first rolling member RB1 may include at least two rolling balls spaced apart from each other in the circumferential direction of the base 40. For example, the first rolling member RB1 may include a first rolling ball RB1a and a second rolling ball RB1b. The second rolling member RB2 may include one rolling ball (e.g., a third rolling ball), and the third rolling member RB3 may include at least one rolling ball (e.g., a fourth rolling ball).

The first rolling member RB1 may be disposed closer to the first aperture magnet 51a than to the second aperture magnet 51b. The second rolling member RB2 may be disposed closer to the second aperture magnet 51b than to the first aperture magnet 51a. The relative position of the third rolling member RB3 with respect to the magnet portion 51 is not limited to any particular example.

A guide groove portion may be formed in a surface of the base 40 and a surface of the rotating body 30 facing each other. For example, a first guide groove portion 42 may be formed in the base 40, and a second guide groove portion 32 may be formed in the rotating body 30.

The rolling portion RB may be disposed between the first guide groove portion 42 and the second guide groove portion 32.

The first guide groove portion 42 may include a 1-1 guide groove 42a, a 1-2 guide groove 42b, a 1-3 guide groove 42c, and a 1-4 guide groove 42d. The 1-1 guide groove 42a to the 1-4 guide groove 42d may be spaced apart from each other in the circumferential direction of the base 40.

The 1-1 guide groove 42a to the 1-4 guide groove 42d may include a bottom surface formed in one surface (e.g., an upper surface) of the base 40, and a side surface extending from the bottom surface toward the rotating body 30 in the optical axis (Z-axis) direction. For example, each of the 1-1 guide groove 42a to the 1-4 guide groove 42d may have a cross section of a ‘┐’ shape.

The second guide groove portion 32 may include a 2-1 guide groove 32a, a 2-2 guide groove 32b, a 2-3 guide groove 32c, and a 2-4 guide groove 32d. The 2-1 guide groove 32a to the 2-4 guide groove 32d may be spaced apart from each other in the circumferential direction of the rotating body 30.

The 2-1 guide groove 32a to the 2-4 guide groove 32d may include a bottom surface formed in one surface (e.g., a lower surface) of the rotating body 30, and a side surface extending from the bottom surface toward the base 40 in the optical axis (Z-axis) direction. For example, each of the 2-1 guide groove 32a to the 2-4 guide groove 32d may have a cross-section of a ‘¬’ shape.

The 1-1 guide groove 42a and the 2-1 guide groove 32a may be disposed facing each other, and one of the two rolling balls (e.g., the first rolling ball RB1a) of the first rolling member RB1 may be disposed in a space between the 1-1 guide groove 42a and the 2-1 guide groove 32a.

The bottom surface of the 1-1 guide groove 42a and the bottom surface of the 2-1 guide groove 32a may face each other in the optical axis (Z-axis) direction, and the side surface of the 1-1 guide groove 42a and the side surface of the 2-1 guide groove 32a may face each other in a direction perpendicular to the optical axis (Z-axis).

Also, the 1-2 guide groove 42b and the 2-2 guide groove 32b may be disposed facing each other, and the other one of the two rolling balls (e.g., the second rolling ball RB1b) of the first rolling member RB1 may be disposed in a space between the 1-2 guide groove 42b and the 2-2 guide groove 32b.

The bottom surface of the 1-2 guide groove 42b and the bottom surface of the 2-2 guide groove 32b may face each other in the optical axis (Z-axis) direction, and the side surface of the 1-2 guide groove 42b and the side surface of the 2-2 guide groove 32b may face each other in a direction perpendicular to the optical axis (Z-axis).

The first rolling ball RB1a of the first rolling member RB1 may be in two-point contact with each of the 1-1 guide groove 42a and the 2-1 guide groove 32a.

For example, the first rolling ball RB1a may be in two-point contact with the 1-1 guide groove 42a, and may be in two-point contact with the 2-1 guide groove 32a. As an example, the first rolling ball RB1a may be in contact with the bottom surface and the side surface of the 1-1 guide groove 42a, and may be in contact with the bottom surface and the side surface of the 2-1 guide groove 32a.

A contact point of the bottom surface of the 1-1 guide groove 42a and a contact point of the bottom surface of the 2-1 guide groove 32a may face each other in the optical axis (Z-axis) direction, and a contact point of the side surface of the 1-1 guide groove 42a and a contact point of the side surface of the 2-1 guide groove 32a may face each other in a direction perpendicular to the optical axis (Z-axis).

For example, a virtual line connecting the contact point of the bottom surface of the 1-1 guide groove 42a to the contact point of the bottom surface of the 2-1 guide groove 32a, and a virtual line connecting the contact point of the side surface of the 1-1 guide groove 42a to the contact point of the side surface of the 2-1 guide groove 32a, may have a ‘+’ shape when viewed in a circumferential direction of the base 40 and the rotating body 30.

The second rolling ball RB1 b of the first rolling member RB1 may be in two-point contact with the 1-2 guide groove 42b and the 2-2 guide groove 32b.

For example, the second rolling ball RB1b may be in two-point contact with the 1-2 guide groove 42b, and may be in two-point contact with the 2-2 guide groove 32b. As an example, the second rolling ball RB1 b may be in contact with the bottom surface and the side surface of the 1-2 guide groove 42b, and may be in contact with the bottom surface and the side surface of the 2-2 guide groove 32b.

The contact point of the bottom surface of 1-2 guide groove 42b and the contact point of the bottom surface of 2-2 guide groove 32b may face each other in the optical axis (Z-axis) direction, and the contact point of the side surface of the 1-2 guide groove 42b and the contact point of the side surface of the 2-2 guide groove 32b may face each other in a direction perpendicular to the optical axis (Z-axis).

For example, a virtual line connecting the contact point of the bottom surface of the 1-2 guide groove 42b to the contact point of the bottom surface of the 2-2 guide groove 32b, and a virtual line connecting the contact point of the side surface of the 1-2 guide groove 42b to the contact point of the side surface of the 2-2 guide groove 32b, may have a ‘+’ shape when viewed in a circumferential direction of the base 40 and the rotating body 30.

The first rolling member RB1, the 1-1 guide groove 42a, the 1-2 guide groove 42b, the 2-1 guide groove 32a, and the 2-2 guide groove 32b may function as a main guide to guide rotation of the rotating body 30.

The 1-3 guide groove 42c and the 2-3 guide groove 32c may be disposed facing each other, and the second rolling member RB2 may be disposed in a space between the 1-3 guide groove 42c and the 2-3 guide groove 32c.

The bottom surface of the 1-3 guide groove 42c and the bottom surface of the 2-3 guide groove 32c may face each other in the optical axis (Z-axis) direction, and the side surface of the 1-3 guide groove 42c and the side surface of the 2-3 guide groove 32c may face each other in a direction perpendicular to the optical axis (Z-axis).

The second rolling member RB2 may be in contact with the 1-3 guide groove 42c and the 2-3 guide groove 32c. The number of contact points between the second rolling member RB2, and the 1-3 guide groove 42c and the 2-3 guide groove 32c, may be two or three.

For example, when the number of contact points between the second rolling member RB2, and the 1-3 guide groove 42c and the 2-3 guide groove 32c, is two, the second rolling member RB2 may be in contact with the bottom surface of the 1-3 guide groove 42c and the bottom surface of the 2-3 guide groove 32c.

When the number of contact points between the second rolling member RB2, and the 1-3 guide groove 42c and the 2-3 guide groove 32c, is three, the second rolling member RB2 may be in contact with the bottom surface of the 1-3 guide groove 42c and the bottom surface of the 2-3 guide groove 32c, and may be in contact with either the side surface of the 1-3 guide groove 42c or the side surface of the 2-3 guide groove 32c.

A distance between the side surface of the 1-3 guide groove 42c and the side surface of the 2-3 guide groove 32c facing each other in a direction perpendicular to the optical axis (Z-axis) direction may be greater than the diameter of the second rolling member RB2.

The second rolling member RB2, the 1-3 guide groove 42c, and the 2-3 guide groove 32c may function as an auxiliary guide to support rotation of the rotating body 30.

When viewed in the optical axis (Z-axis) direction, the rotating body 30 may be three-point supported on the base 40 by the first rolling member RB1 and the second rolling member RB2 (e.g., a triangular support region).

The 1-4 guide groove 42d and the 2-4 guide groove 32d may be disposed facing each other, and the third rolling member RB3 may be disposed in a space between the 1-4 guide groove 42d and the 2-4 guide groove 32d.

The bottom surface of the 1-4 guide groove 42d and the bottom surface of the 2-4 guide groove 32d may face each other in the optical axis (Z-axis) direction, and the side surface of the 1-4 guide groove 42d and the side surface of the 2-4 guide groove 32d may face each other in a direction perpendicular to the optical axis (Z-axis).

The third rolling member RB3 may be in contact with either one or both of the 1-4 guide groove 42d and the 2-4 guide groove 32d. The number of contact points between the third rolling member RB3, and the 1-4 guide groove 42d and the 2-4 guide groove 32d, may be one or two.

For example, when the number of contact points between the third rolling member RB3, and the 1-4 guide groove 42d and the 2-4 guide groove 32d, is one, the third rolling member RB3 may be in contact with the bottom surface of the 1-4 guide groove 42d or the bottom surface of the 2-4 guide groove 32d.

When the number of contact points between the third rolling member RB3, and the 1-4 guide groove 42d and the 2-4 guide groove 32d, is two, the third rolling member RB3 may be in one-point contact with either the bottom surface of the 1-4 guide groove 42d or the bottom surface of the 2-4 guide groove 32d, and may be in one-point contact with either the side surface of the 1-4 guide groove 42d or the side surface of the 2-4 guide groove 32d.

In an embodiment, a distance in the optical axis (Z-axis) direction between the bottom surface of the 1-4 guide groove 42d and the bottom surface of the 2-4 guide groove 32d may be greater than a distance in the optical axis (Z-axis) direction between the bottom surface of the 1-1 guide groove 42a and the bottom surface of the 2-1 guide groove 32a.

In an embodiment, a distance in the optical axis (Z-axis) direction between the bottom surface of the 1-4 guide groove 42d and the bottom surface of the 2-4 guide groove 32d may be greater than the diameter of the fourth rolling ball of the third rolling member RB3.

In an embodiment, the diameter of the fourth rolling ball of the third rolling member RB3 may be smaller than the diameter of the first and second rolling balls RB1a and RB1b of the first rolling member RB1 and the diameter of the third rolling ball of the second rolling member RB2.

The third rolling member RB3 may function to prevent the rotating body 30 from being tilted relative to the base 40 during an external impact. That is, by preventing the rotating body 30 from being tilted with respect to the base 40 during an external impact, the rolling portion RB may be prevented from being separated from the base 40 and the rotating body 30.

However, the third rolling member RB3 may be an optional component, and when the third rolling member RB3 is not provided, tilting of the rotating body 30 may be prevented by adjusting positions of the first rolling member RB1 and the second rolling member RB2.

When viewed in the optical axis (Z-axis) direction, the rotating body 30 may be three-point supported on the base 40 by the first rolling member RB1 and the second rolling member RB2.

In this case, a central point CP of an attractive force acting between the magnet portion 51 and the pulling yoke portion 55 may need to be disposed in a support region connecting the contact points of the first rolling member RB1 and the base 40 (or rotating body 30) and the contact points of the second rolling member RB2 and the base 40 (or rotating body 30).

Since a width of the support region may increase toward the first rolling member RB1, the central point CP of the attractive force may need to be disposed closer to the first rolling member RB1.

To this end, by configuring the sizes of the first pulling yoke 55a and the second pulling yoke 55b differently, the central point CP of the attractive force may be disposed closer to the first rolling member RB1.

In an embodiment, the area of the first pulling yoke 55a facing the first aperture magnet 51a may be greater than the area of the second pulling yoke 55b facing the second aperture magnet 51b.

In other words, by configuring the size of the first pulling yoke 55a to be greater than the size of the second pulling yoke 55b, the central point CP of the attractive force may be disposed closer to the first rolling member RB1.

As another example, by configuring the size of the first aperture magnet 51a to be greater than the size of the second aperture magnet 51b, the central point CP of the attractive force may be disposed closer to the first rolling member RB1.

As another example, by configuring the distance in the optical axis (Z-axis) direction between the first aperture magnet 51a and the first pulling yoke 55a to be less than the distance in the optical axis (Z-axis) direction between the second aperture magnet 51b and the second pulling yoke 55b, the central point CP of the attractive force may be disposed closer to the first rolling member RB1.

The first pulling yoke 55a may be configured so that an area of one portion thereof may be greater than an area of remaining portion thereof. For example, the first pulling yoke 55a may have a rectangular shape and may have a protrusion protruding from a portion of a long side of the rectangle. Accordingly, the relative position of the first aperture magnet 51a with respect to the first pulling yoke 55a may be maintained to be constant when power is not applied to the aperture driving unit 50.

In an embodiment, the first pulling yoke 55a may have an asymmetric shape with respect to a center of the first pulling yoke 55a. For example, with respect to a virtual line passing through the optical axis (Z-axis) and crossing the center of the first pulling yoke 55a, an area of the first pulling yoke 55a on one side of the virtual line may be greater than an area of the first pulling yoke 55a on the other side of the virtual line.

As another example, a width of the first pulling yoke 55a may be configured to increase from one end in the length direction to the other end in the length direction.

As another example, the first pulling yoke 55a may be provided as two yokes disposed adjacent to each other. In this case, the size of one of the two yokes may be greater than the size of the other one of the two yokes.

The aperture module 100′ may further include an auxiliary yoke 56.

The auxiliary yoke 56 may be disposed closer to the first aperture magnet 51a than to the second aperture magnet 51b.

When viewed in the optical axis (Z-axis) direction, the first aperture magnet 51a, the first pulling yoke 55a, and the auxiliary yoke 56 may be disposed in a space between the first rolling ball RB1a and the second rolling ball RB1b.

The auxiliary yoke 56 may be disposed on a side wall extending in the optical axis (Z-axis) direction from the surface of the base 40. For example, the auxiliary yoke 56 may be disposed so that at least a portion thereof may face the first aperture magnet 51a in a direction perpendicular to the optical axis (Z-axis). The auxiliary yoke 56 may be made of a magnetic material. In an embodiment, the auxiliary yoke 56 may be disposed on an inner surface of the side wall of the base 40. This can best be seen in FIG. 14.

The auxiliary yoke 56 may be integrally coupled with the base 40 by insert injection molding. In this case, the auxiliary yoke 56 may be integrated with the base 40 during manufacturing by injecting a resin material into a mold in which the auxiliary yoke 56 has been inserted.

In an embodiment, a position of a top of the auxiliary yoke 56 may be disposed between an upper surface and a lower surface of the first aperture magnet 51a in the optical axis (Z axis) direction.

Referring to FIG. 16, an attractive force may be applied in the direction of the optical axis (Z-axis) by the first aperture magnet 51a and the first pulling yoke 55a, an attractive force may be applied in a direction (e.g., a direction perpendicular to the optical axis (Z-axis) or a direction sloped downwardly while intersecting the optical axis (Z-axis)) intersecting the optical axis (Z-axis) by the first aperture magnet 51a and the auxiliary yoke 56.

In other words, an attractive force may act on the first aperture magnet 51a in at least two directions intersecting each other.

Due to the attractive force acting between the first aperture magnet 51a and the first pulling yoke 55a, the rotating body 30 including the first aperture magnet 51a may be pulled in the direction of the optical axis (Z-axis) toward the base 40 including the first pulling yoke 55a.

Accordingly, due to the attractive force acting between the first aperture magnet 51a and the first pulling yoke 55a, the first rolling ball RB1a may be held in contact with the bottom surface of the 1-1 guide groove 42a and the bottom surface of the 2-1 guide groove 32a.

Due to the attractive force acting between the first aperture magnet 51a and the first pulling yoke 55a, the second rolling ball RB1b may be held in contact with the bottom surface of the 1-2 guide groove 42b and the bottom surface of the 2-2 guide groove 32b.

Due to the attractive force acting between the first aperture magnet 51a and the auxiliary yoke 56, the rotating body 30 including the first aperture magnet 51a may be pulled toward the base 40 including the auxiliary yoke 56 in a direction intersecting the optical axis (Z-axis).

Accordingly, due to the attractive force acting between the first aperture magnet 51a and the auxiliary yoke 56, the first rolling ball RB1a may be held in contact with the side surface of the 1-1 guide groove 42a and the side surface of the 2-1 guide groove 32a.

Also, due to the attractive force acting between the first aperture magnet 51a and the auxiliary yoke 56, the second rolling ball RB1 b may be held in contact with the side surface of the 1-2 guide groove 42b and the side surface of the 2-2 guide groove 32b.

Each of the side surface of the 1-1 guide groove 42a, the side surface of the 1-2 guide groove 42b, the side surface of the 2-1 guide groove 32a, and the side surface of the 2-2 guide groove 32b may be a curved surface.

For example, a radius of curvature of the side surface of the 1-1 guide groove 42a and a radius of curvature of the side surface of the 1-2 guide groove 42b may be the same. Also, a radius of curvature of the side surface of the 2-1 guide groove 32a and a radius of curvature of the side surface of the 2-2 guide groove 32b may be the same.

Also, a virtual circle passing through the side surface of the 1-1 guide groove 42a and the side surface of the 1-2 guide groove 42b, and a virtual circle passing through the side surface of the 2-1 guide groove 32a and the side surface of the 2-2 guide groove 32b, may be concentric.

The auxiliary yoke 56 may be disposed further out in a direction perpendicular to the optical axis (Z-axis) than the virtual circle passing through the side surface of the 1-1 guide groove 42a and the side surface of the 1-2 guide groove 42b. Also, the auxiliary yoke 56 may be disposed further out in a direction perpendicular to the optical axis (Z-axis) than the virtual circle passing through the side surface of the 2-1 guide groove 32a and the side surface of the 2-2 guide groove 32b.

When a driving force is generated by the aperture driving unit 50, the first rolling ball RB1a may roll along the side surface of the 1-1 guide groove 42a and the side surface of the 2-1 guide groove 32a, and the second rolling ball RB1b may roll along the side surface of the 1-2 guide groove 42b and the side surface of the 2-2 guide groove 32b.

Accordingly, the rotating body 30 may rotate by being guided by the first rolling ball RB1a and the second rolling ball RB1b.

Referring to FIG. 16, an attractive force may be applied in the direction of the optical axis (Z-axis) by the second aperture magnet 51b and the second pulling yoke 55b.

Due to the attractive force acting between the second aperture magnet 51b and the second pulling yoke 55b, the rotating body 30 including the second aperture magnet 51b may be pulled in the direction of the optical axis (Z-axis) toward the base 40 including the second pulling yoke 55b.

When the rotating body 30 rotates, due to the attractive force acting between the second aperture magnet 51b and the second pulling yoke 55b, the second rolling member RB2 may be held in contact with the bottom surface of the 1-3 guide groove 42c and the bottom surface of the 2-3 guide groove 32c, and the rotating body 30 may maintain a three-point support for the rolling portion RB.

In an embodiment, the aperture module 100′ may sense a position of the rotating body 30.

To this end, a aperture position sensor 53 may be provided. The aperture position sensor 53 may be disposed on the aperture substrate 54 facing the magnet portion 51. For example, the aperture position sensor 53 may face either one or both of the first aperture magnet 51a and the second aperture magnet 51b in the optical axis (Z-axis) direction.

The aperture position sensor 53 may be a Hall sensor.

According to the aforementioned embodiments, the camera module may control the amount of incident light and may reduce power consumption when moving the lens module.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
an aperture module configured to move in a direction of one or more axes among three axes intersecting each other and comprising an entrance hole configured to allow light to pass therethrough in an optical axis direction;
a lens module coupled to the aperture module and configured to move together with the aperture module;
a housing accommodating the aperture module and the lens module;
an aperture driving unit configured to generate a driving force to change a size of the entrance hole and comprising an aperture magnet and an aperture coil facing the aperture magnet; and
an actuator driving unit configured to generate a driving force in the direction of one or more of the axes to move the aperture module, and comprising one or more magnets and one or more coils facing the one or more magnets,
wherein the aperture magnet or the aperture coil is disposed on the aperture module, and
the one or more magnets or the one or more coils are disposed on the aperture module.

2. The camera module of claim 1, wherein the lens module comprises a first lens unit and a second lens unit spaced apart from each other in the optical axis direction, and
the aperture module is disposed between the first lens unit and the second lens unit.

3. The camera module of claim 2, wherein the aperture module further comprises:
a base and a cover coupled to each other and forming an internal space; and
a plurality of blades forming the entrance hole and disposed in the internal space, and
the first lens unit is mounted on an upper surface of the cover, and the second lens unit is accommodated in the base.

4. The camera module of claim 1, wherein the aperture module further comprises:
a base;
a plurality of blades forming the entrance hole, coupled to the base, and configured to rotate; and
a holder configured to move in a direction perpendicular to the optical axis direction with respect to the base, and
the aperture magnet is disposed on the holder, and the aperture coil is disposed on the housing.

5. The camera module of claim 4, wherein the lens module is accommodated in the base,
the one or more magnets comprise a plurality of magnets disposed on the base, and
the plurality of magnets are disposed below the aperture magnet in the optical axis direction.

6. The camera module of claim 5, wherein the aperture module further comprises an extension portion extending downwardly in the optical axis direction from two sidewalls of the base, and
the plurality of magnets are disposed on the extension portion.

7. The camera module of claim 1, wherein the aperture module and the lens module are further configured to move together in a first axis direction perpendicular to the optical axis direction and a second axis direction perpendicular to both the optical axis direction and the first axis direction,
the one or more magnets comprise a plurality of magnets disposed on the aperture module, and
the one or more coils comprise a plurality of coils disposed on the housing.

8. The camera module of claim 1, further comprising:
a carrier disposed in the housing; and
a focus adjustment unit comprising a first magnet disposed on the carrier and a first coil facing the first magnet,
wherein the aperture module and the lens module are disposed in the carrier.

9. The camera module of claim 8, wherein the aperture module further comprises:
a base; and
a plurality of blades forming the entrance hole, coupled to the base, and configured to rotate,
the one or more magnets comprise a second magnet and a third magnet both disposed on the base, and
the one or more coils comprise a second coil facing the second magnet and a third coil facing the third magnet.

10. The camera module of claim 9, further comprising a plurality of ball members disposed between the base and the carrier.

11. The camera module of claim 10, further comprising a plurality of guide grooves accommodating the plurality of ball members and formed in a surface of the base and a surface of the carrier facing each other in the optical axis direction, and
wherein a size of the guide groove is greater than a size of the plurality of ball members.

12. The camera module of claim 9, further comprising:
a guide frame disposed between the aperture module and the carrier;
a plurality of ball members disposed between the carrier and the guide frame; and
a plurality of ball members disposed between the guide frame and the aperture module.

13. The camera module of claim 1, wherein the aperture module and the lens module are configured to move together in the optical axis direction,
the one or more magnets comprise a first magnet disposed on the aperture module, and
the one or more coils comprise a first coil facing the first magnet.

14. The camera module of claim 13, further comprising an optical image stabilization (OIS) carrier disposed in the housing,
wherein the aperture module and the lens module are disposed in the OIS carrier, and
the OIS carrier, the aperture module, and the lens module are configured to move together in a first axis direction perpendicular to the optical axis direction, and a second axis direction perpendicular to both the optical axis direction and the first axis direction.

15. The camera module of claim 14, wherein the one or more magnets further comprise a second magnet and a third magnet disposed on the OIS carrier, and
the one or more coils further comprise a second coil disposed on the housing and facing the second magnet, and a third coil disposed on the housing and facing the third magnet.

16. The camera module of claim 14, further comprising:
a guide frame disposed between the OIS carrier and the housing;
a plurality of ball members disposed between the housing and the guide frame; and
a plurality of ball members disposed between the guide frame and the OIS carrier.

17. The camera module of claim 14, further comprising a first substrate disposed on the OIS carrier and comprising a portion made of a flexible material,
wherein the aperture magnet is disposed on the aperture module, and
the first coil and the aperture coil are disposed on the first substrate.

18. A camera module comprising:
an aperture module configured to move in an optical axis direction, a first axis direction perpendicular to the optical axis direction, and a second axis direction perpendicular to both the optical axis direction and the first axis direction, and comprising an entrance hole configured to allow light to pass therethrough in the optical axis direction;
a lens module coupled to the aperture module and configured to move together with the aperture module;
a carrier accommodating the aperture module and the lens module;
a housing accommodating the carrier; and
an optical image stabilization unit comprising a plurality of magnets disposed on the aperture module, and a plurality of coils disposed on the housing,
wherein an attractive force acts between the aperture module and the carrier in the optical axis direction.

19. The camera module of claim 18, further comprising:
an aperture driving unit comprising an aperture magnet disposed on the aperture module, and an aperture coil disposed on the housing; and
a focus adjustment unit comprising a first magnet disposed on the carrier, and a first coil disposed on the housing,
wherein the aperture magnet and one of the plurality of magnets are spaced apart from each other in the first axis direction, and the first magnet and another one of the plurality of magnets are spaced apart from each other in the second axis direction.

20. A camera module comprising:
an aperture module configured to move in an optical axis direction, a first axis direction perpendicular to the optical axis direction, and a second axis direction perpendicular to both the optical axis direction and the first axis direction, and comprising an entrance hole configured to allow light to pass therethrough in the optical axis direction;
a lens module coupled to the aperture module and configured to move together with the aperture module;
an optical image stabilization (OIS) carrier accommodating the aperture module and the lens module;
a housing accommodating the OIS carrier; and
a focus adjustment unit comprising a first magnet disposed on the aperture module, and a first coil facing the first magnet,
wherein an attractive force acts between the aperture module and the OIS carrier in a direction perpendicular to the optical axis direction.

21. The camera module of claim 20, further comprising:
an aperture driving unit comprising an aperture magnet disposed on the aperture module, and an aperture coil facing the aperture magnet;
a first substrate coupled to the OIS carrier and having the first coil and the aperture coil disposed thereon; and
an optical image stabilization unit comprising a second magnet and a third magnet disposed on the OIS carrier, and a second coil and a third coil disposed on the housing,
wherein a portion of the first substrate is spaced apart from the OIS carrier in a direction perpendicular to the optical axis direction, extends along a side surface of the OIS carrier, and is mounted on an external side surface of the housing.

22. An aperture module comprising:
a base configured to move in an optical axis direction, a first axis direction perpendicular to the optical axis direction, and a second axis direction perpendicular to both the optical axis direction and the first axis direction;
a plurality of blades coupled to the base, forming an entrance hole configured to allow light to pass therethrough in the optical axis direction, and configured to rotate relative to the base to change a size of the entrance hole;
an aperture magnet coupled to the base and configured to rotate the blades to change the size of the entrance hole; and
a plurality of magnets mounted on the base and configured to move the base in the first axis direction and the second axis direction.

23. The aperture module of claim 22, further comprising a holder disposed on the base, coupled to the plurality of blades, and configured to move in the first axis direction or the second axis direction relative to the base to rotate the blades to change the size of the entrance hole,
wherein the aperture magnet is disposed on the holder.

24. The aperture module of claim 22, further comprising:
a rotating body disposed between the base and the plurality of blades, coupled to the plurality of blades, and configured to rotate relative to the base to rotate the blades to change the size of the entrance hole; and
an aperture coil disposed between the base and the rotating member and coupled to the base,
wherein the aperture magnet is disposed on the rotating body facing the aperture coil, and cooperates with the aperture coil to rotate the rotating body to rotate the blades to change the size of the entrance hole.

25. The aperture module of claim 24, further comprising a first magnet disposed on the base and configured to move the base in the optical axis direction,
wherein the plurality of magnets comprise:
a second magnet disposed on the base and configured to move the base in the first axis direction; and
a third magnet disposed on the base and configured to move the base in the second axis direction.

26. A camera module comprising:
the aperture module of claim 22; and
a carrier configured to move in the optical axis direction, the first axis direction, and the second axis direction,
wherein the aperture module is disposed in the carrier and is configured to move in the optical axis direction, the first axis direction, and the second axis direction together with the carrier,
the camera module further comprises a first magnet mounted on the carrier and configured to move the carrier and the aperture module in the optical axis direction, and
the plurality of magnets comprise:
a second magnet mounted on the base and configured to move the aperture module and the carrier in the first axis direction; and
a third magnet mounted on the base and configured to move the aperture module and the carrier in the second axis direction.

27. An aperture module comprising:
a base configured to move in an optical axis direction, a first axis direction perpendicular to the optical axis direction, and a second axis direction perpendicular to both the optical axis direction and the first axis direction;
a plurality of blades coupled to the base, forming an entrance hole configured to allow light to pass therethrough in the optical axis direction, and configured to rotate relative to the base to change a size of the entrance hole;
an aperture magnet coupled to the base and configured to rotate the blades to change the size of the entrance hole; and
a first magnet mounted on the base and configured to move the base in the optical axis direction.

28. The aperture module of claim 27, further comprising a holder disposed on the base, coupled to the plurality of blades, and configured to move in the first axis direction or the second axis direction relative to the base to rotate the blades to change the size of the entrance hole,
wherein the aperture magnet is disposed on the holder.

29. A camera module comprising:
the aperture module of claim 27; and
an optical image stabilization (OIS) carrier configured to move in the first axis direction and the second axis direction,
wherein the aperture module is disposed in the OIS carrier and is configured to move in the optical axis direction relative to the OIS carrier, and the first axis direction and the second axis direction together with the OIS carrier,
the first magnet is further configured to move the aperture module in the optical axis direction relative to the carrier, and
the camera module further comprises:
a second magnet mounted on the OIS carrier and configured to move the OIS carrier and the aperture module in the first axis direction; and
a third magnet mounted on the OIS carrier and configured to move the OIS carrier and the aperture module in the second axis direction.
